(19) United States
(12) Patent Application Publication
(10) Pub. No.: US 2003/0070692 A1
(43) Pub. Date: Apr. 17, 2003

(54) Peroxygen compositions and methods for carpet or upholstery cleaning or sanitizing

(76) Inventors: Kim R. Smith, Woodbury, MN (US); Matthew Jon Finley, Shakopee, MN (US); Keith E. Olson, Apple Valley, MN (US); Victor Fuk-Pong Man, St. Paul, MN (US); Tami J. Tadrowski, Greensborough, NC (US); Mark Levitt, St. Paul, MN (US)

Correspondence Address: MERCHANT & GOULD PC, P.O. BOX 2903, MINNEAPOLIS, MN, 55402-0903, US

(21) Appl. No.: 09/923,931

(22) Filed: Aug. 7, 2001

(51) Int. Cl. B08B 7/00; B08B 3/14; C11D 1/00; C11D 3/00; C11D 7/18; C11D 7/54; C11D 9/42; D06L 1/00

(52) U.S. Cl. 134/6; 134/42; 15/320; 510/278; 510/281; 510/302

(57) ABSTRACT

The present invention relates to methods and compositions for cleaning or sanitizing carpet or upholstery. Powder, other solid, or agglomerate compositions include active oxygen compound, surfactant, and builder. The methods of cleaning or sanitizing carpet or upholstery include applying to the carpet or upholstery such a solid (e.g., powder) or agglomerate composition or a use solution of one of these compositions.

### FIELD OF THE INVENTION

The present invention relates to methods and compositions for cleaning or sanitizing carpet or upholstery. Powder, other solid, or agglomerate compositions include active oxygen compound, surfactant, and builder. The methods of cleaning or sanitizing carpet or upholstery include applying to the carpet or upholstery such a solid (e.g., powder) or agglomerate composition or a use solution of one of these compositions.

### BACKGROUND OF THE INVENTION

Carpet cleaning, carpet sanitizing, upholstery cleaning, and upholstery sanitizing each represent a substantial service industry in the United States and other industrialized nations. Upward of several billion dollars per year are spent on carpet and upholstery cleaning and sanitizing services in the United States alone. Conventional cleaning or sanitizing methods or compositions can remove substantial amounts of dirt, stains, and microbial contamination. These conventional methods and compositions, however, still leave behind noticeable stains and ground in dirt, which often must be removed by an additional pre-spotting step. In addition, typical conventional sanitizing compositions, such as quaternary ammonium compounds, have only minimal effect on dirt and stains. Even worse, due to their positive charge, quaternary ammonium sanitizing compositions often lead to accelerated build-up of anionic soils. Conversely, typical cleaning compositions might physically clean away some microbes, but they do not sanitize, the microbes remain viable.

There remains a need for improved methods and compositions for accomplishing one or more of cleaning, removing spots from, or sanitizing carpets or upholstery.

### SUMMARY OF THE INVENTION

The present invention relates to methods and compositions for cleaning or sanitizing carpet or upholstery. Powder, other solid, or agglomerate compositions include active oxygen compound, surfactant, and builder. The methods of cleaning or sanitizing carpet or upholstery include applying to the carpet or upholstery such a solid (e.g., powder) or agglomerate composition or a use solution of one of these compositions.

In an embodiment, the present method of cleaning carpet or upholstery includes applying to carpet or upholstery a solid (e.g., powder) or agglomerate cleaning composition. Preferably, the cleaning composition includes active oxygen compound including peroxygen moiety; surfactant; and builder. The composition can be applied in any of a variety of suitable fashions for applying cleaning compositions to carpet or upholstery. For example, the composition can be applied by extracting the carpet or upholstery, preferably without the use of a pre-spotting or pre-spraying step. The method can apply the composition in any form suitable for applying cleaning or sanitizing compositions to carpet or upholstery. For example, in an embodiment, the method can include mixing the cleaning composition with a solvent (preferably water), and applying the mixture of the cleaning composition and the solvent to the carpet. The method can also include removing at least part of the composition from the carpet.

In an embodiment, the method is effective for sanitizing the carpet or upholstery. The method of sanitizing can include applying to the carpet a solid (e.g., powder) or agglomerate cleaning composition, the composition including active oxygen compound including peroxygen moiety; surfactant; and builder. Preferably, the method of cleaning and/or the method of sanitizing include applying the cleaning composition at a concentration and for a duration effective to achieve sanitizing the carpet.

In an embodiment, the method employs a cleaning composition including about 1 to about 99 wt-% active oxygen compound; about 0.1 to about 50 wt-% surfactant; and about 1 to about 99 wt-% builder. Preferably, the cleaning composition includes about 15 to about 65 wt-% active oxygen compound; about 2 to about 20 wt-% surfactant; and about 15 to about 65 wt-% builder. Preferably, the cleaning composition includes about 50 to about 70 wt-% active oxygen compound; about 7 to about 11 wt-% surfactant; and about 20 to about 35 wt-% builder.

In an embodiment, the invention includes a cleaning composition suitable for cleaning or sanitizing carpet or upholstery. The composition of the invention is a solid (e.g., powder) or agglomerate and includes active oxygen compound, surfactant, and builder. Typically such a composition includes about 1 to about 99 wt-% active oxygen compound; about 0.1 to about 50 wt-% surfactant; and about 1 to about 99 wt-% builder. Preferably, such a composition includes about 40 to about 90 wt-% active oxygen compound; about 1 to about 11 wt-% surfactant; and about 20 to about 60 wt-% builder. Preferably, the cleaning composition includes about 50 to about 70 wt-% active oxygen compound; about 7 to about 11 wt-% surfactant; and about 20 to about 35 wt-% builder.

In some embodiments, other optional ingredients can be incorporated into the composition, including, for example, salt or additional salt, alkalinity source, acidity source, pH buffer, hardening agent, debrowning agent, solubility modifier, detergent filler, water softener, defoamer, anti-redeposition agent, precipitation threshold agent or system, antimicrobial agent, aesthetic enhancing agent (i.e., dye, odorant, perfume), optical brightener, bleaching agent, enzyme, effervescent agent, activator for the active oxygen compound, other such additives or functional ingredients, and the like, and mixtures thereof.

### BRIEF DESCRIPTION OF THE FIGURES

FIG. 1 is a digital photograph of a carpet before cleaning with a composition according to and by a method of the present invention.

FIG. 2 is a digital photograph of the carpet of FIG. 1 after cleaning with a conventional, commercial carpet cleaning detergent.

FIG. 3 is a digital photograph of the carpet of FIG. 1 after cleaning with a composition according to and by a method of the present invention.

FIG. 4 is a digital photograph of the carpet of FIG. 1 after a portion was cleaned with a conventional, commercial carpet cleaning detergent and another portion was cleaned with a composition according to and by a method of the present invention.

FIG. 5 is a digital photograph of a carpet extractor as employed for cleaning the carpet.

### DETAILED DESCRIPTION OF THE INVENTION

Definitions

An “active oxygen compound” is an agent containing or acting as a source of active oxygen. Preferred active oxygen compounds release active oxygen in aqueous solutions.

A “peroxygen compound” or “peroxide” means a compound containing a peroxy moiety, —O—O—, or adducts of such compounds, in which at least one of the oxygen atoms is active.

An “active oxygen compound adduct” is a physical adduct containing active oxygen compound associated with a second molecule.

A “peroxygen compound adduct” is a physical adduct containing peroxygen compound associated with a second molecule.

A “hydrogen peroxide adduct” or a “peroxyhydrate” is an adduct containing molecular hydrogen peroxide. On dissolution in water, hydrogen peroxide adducts (peroxyhydrates) liberate hydrogen peroxide into solution.

“Inorganic active oxygen compound(s)” are active oxygen compounds wherein the active oxygen is attached to an inorganic group, or it can bridge two inorganic groups.

“Inorganic peroxide” compounds are peroxygen compound wherein the peroxide group is attached to an inorganic group through one or two of the oxygen atoms, or it can bridge two inorganic groups.

“Organic active oxygen compound(s)” are active oxygen compounds wherein the active oxygen is attached to a group containing carbon, or it can bridge two groups containing carbon.

“Organic peroxide” compounds are peroxygen compounds wherein the peroxide group is attached to a group containing carbon or phosphorus through one or two of the oxygen atoms, or it can bridge two groups containing carbon.

“Phosphonate” means a class of organophosphonic acids including one of the general formula:

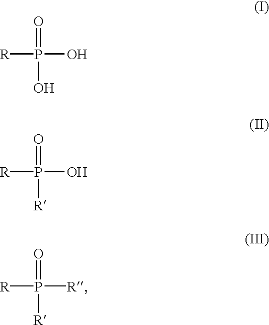

and acceptable salts and esters thereof, wherein R, R′ and R′″ are each organic groups. The phosphonate of formula I is typically preferred.

An “aminocarboxylic acid” is an acid having at least one amino group and at least one carboxylic acid substituent.

An “alkali metal carbonate” is a compound including at least one alkali metal and at least one carbonate group.

The term “functional material” or “functional additives” refers to an active compound or material that affords desirable properties to the solid (e.g., powder), agglomerate, dissolved, or suspended composition. For example, the functional material can afford desirable properties to the solid (e.g., powder) or agglomerate composition such as enhancing solidification characteristics or dilution rate. The functional material can also, when dissolved or dispersed in an aqueous phase, provide a beneficial property to the aqueous material when used. Examples of functional materials include surfactant, softening agent, buffer, anti-corrosion agent, bleach activator, hardening agent, solubility modifier, detergent filler, defoamer, anti-redeposition agent, antimicrobial, a precipitation threshold agent or system, aesthetic enhancing agent (i.e., dye, perfume), bleaching agent, functional salt, hardening agent, enzyme, other such additive or functional ingredient, and the like, and mixtures thereof. Functional materials added to a composition will vary according to the type of composition being manufactured, and the intended end use of the composition.

“Cleaning” means to perform or aid in soil removal, bleaching, or combination thereof.

As used herein, a solid cleaning composition refers to a cleaning composition in the form of a solid such as a powder, a flake, a granule, a pellet, a tablet, a lozenge, a puck, a briquette, a brick, a solid block, a unit dose, or another known solid form.

As used herein, the term “agglomerate” refers to a cleaning composition including particles gathered together to form a larger particle having varying degrees of open spaces or voids between its individual component particles.

As used herein, the term “microorganism” refers to any noncellular or unicellular (including colonial) organism. Microorganisms include all prokaryotes. Microorganisms include bacteria (including cyanobacteria and Mycobacteria), lichens, fungi, mold, protozoa, virinos, viroids, viruses, and some algae. As used herein, the term “microbe” is synonymous with microorganism.

As used herein, weight percent (wt-%), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can effect two kinds of microbial cell damage. The first is a lethal, irreversible action resulting in complete microbial cell destruction or incapacitation. The second type of cell damage is reversible, such that if the organism is rendered free of the agent, it can again multiply. The former is termed bacteriocidal and the later, bacteriostatic. A sanitizer and a disinfectant are, by definition, agents which provide antibacterial or bacteriocidal activity. In contrast, a preservative is generally described as an inhibitor or bacteriostatic composition.

For the purpose of this patent application, successful reduction of microorganisms is achieved when the populations of microorganisms are reduced by at least about 0.3-1 log₁₀. In this application, such a population reduction is the minimum acceptable for the processes.

Any increased reduction in population of microorganisms is an added benefit that provides higher levels of protection. For example, a carpet sanitizer results in a 99.9% reduction (3 log order reduction ) in one or more microorganisms in a carpet sample in a test procedure defined by the EPA at US EPA—Efficacy Data Requirements: Carpet Sanitizers DIS/TSS-8 Apr. 18, 1981, the contents of which are incorporated herein by reference.

The Solid Carpet or Upholstery Cleaning or Sanitizing Composition

In its most basic aspect, the present carpet or upholstery cleaning or sanitizing composition includes a solid (e.g., powder) or agglomerate mixture of active oxygen compound, surfactant, and builder. The active oxygen compound can provide cleaning, bleaching, antimicrobial activity, and other desirable properties for a carpet cleaning composition. The surfactant advantageously provides soil removal and cleaning power, such as the power to remove material that has been bleached by the active oxygen compound, the power to wash away microbes that have been killed by the active oxygen compound. The surfactant can also provide emulsification, and other desirable properties for a carpet cleaning composition. The builder can provide cleaning, chelating, antimicrobial activity, water softening, active oxygen stabilization, and other desirable properties for a carpet cleaning composition.

This combination of ingredients for a solid (e.g., powder) or agglomerate carpet or upholstery cleaning composition provides advantageous properties for carpet cleaning. The present composition preferably acts as a carpet sanitizer that both kills microbes and/or stops their growth, and also removes living, inert, or dead microbes from the carpet or upholstery. The present composition preferably acts as an antimicrobial composition that reduces the population of microbes in a carpet or upholstery by killing microbes and/or stopping their growth, and also removing living, inert, or dead microbes from the carpet or upholstery. The present composition preferably removes stains from carpet or upholstery by both bleaching the stain and also removing the soil that makes up the stain. The present composition preferably lightens stains on carpet or upholstery by both bleaching the stain and also removing the soil that makes up the stain. The present composition combines the cleaning power of alkaline cleaning agents, such as percarbonate, carbonate, and bicarbonate, with a surfactant to remove stubborn soils in high traffic areas. The present composition preferably removes stains and soil in high traffic areas without pre-spraying and without pre-spotting of these stains or areas with this or another cleaning composition. These are but a selection of the numerous advantages of the present compositions for cleaning or sanitizing carpet or upholstery.

Each of these ingredients can also provide advantageous properties, such as stability, to the solid (e.g., powder) or agglomerate cleaning composition.

The individual ingredients can be selected for their contribution to these various advantages of these compositions. Preferably, the active oxygen compound is selected to be and is employed at a concentration that is effective for bleaching the soil making up a stain on carpet or upholstery. Preferably, the active oxygen compound is selected to be and is employed at a concentration that is effective for reducing the population of microbes on a carpet or upholstery. Preferably, the active oxygen compound is selected to be and is employed at a concentration that is effective for sanitizing carpet. Preferably, the surfactant is selected to be and is employed at a concentration that is effective for removing soil bleached by the active oxygen compound. Preferably, the surfactant is selected to be and is employed at a concentration that is effective for removing microbes killed or rendered moribund or inactive by the active oxygen compound.

Some examples of carpet or upholstery cleaning or sanitizing compositions according to or employed in the methods of the present invention can be found in Table 1, in which the values are given in wt-% of the ingredients in reference to the total composition weight.

TABLE 1
Compositions for Carpet or Upholstery Cleaning and Sanitizing
Composition of or For Use in The Present Invention.

| | Typical wt-% | Preferred wt-% | Preferred wt-% |
|---|---|---|---|
| Component | Range | Range | Range |
| Active Oxygen | 1-99 | 10-80 | 15-65 |
| Compound | | | |
| Surfactant | 0.1-50 | 1-30 | 2-20 |
| Builder | 1-99 | 10-80 | 15-65 |

Additional preferred compositions include the ranges of ingredients listed in Table 2.

TABLE 2
Preferred Compositions for Carpet or
Upholstery Cleaning and Sanitizing

| | Preferred | Preferred | Preferred | |
|---|---|---|---|---|
| | wt-% | wt-% | wt-% | |
| Component | Range | Range | Range | Preferred wt-% |
| Active Oxygen | 40-80 | 50-70 | 50-65 | 60 |
| Compound | | | | |
| Surfactant | 4-15 | 7-11 | 8-10 | 9 |
| Builder | 15-50 | 25-40 | 25-30 | 25 |
| Other Additives | 0-25 | 0-18 | 0-10 | 0-10 |
| Water | 0-10 | 0-5 | 0 | 0 |

Additional preferred compositions include the ranges of ingredients listed in Table 3.

TABLE 3
Additional Preferred Compositions for Carpet or
Upholstery Cleaning and Sanitizing

| | Preferred wt-% | Preferred wt-% | Preferred wt-% |
|---|---|---|---|
| Component | Range | Range | Range |
| Active Oxygen | 50-70 | 30-50 | 50-80 |
| Compound | | | |
| Surfactant | 7-11 | 1-15 | 1-15 |
| Builder | 20-35 | 30-60 | 30-60 |
| Other Additives | | 0-10 | 0-10 |
| Water | 0-5 | 0-5 | 0-5 |

Preferably, the cleaning composition includes about 50 to about 65 wt-% active oxygen compound; about 7 to about 11 wt-% surfactant; and about 20 to about 35 wt-% builder. Preferably, the cleaning composition includes about 60 to about 90 wt-% active oxygen compound; about 1 to about 5 wt-% surfactant; and about 10 to about 40 wt-% builder. Preferably, the cleaning composition includes about 80 to about 90 wt-% active oxygen compound; about 1 to about 4 wt-% surfactant; and about 10 to about 20 wt-% builder. Preferably, the cleaning composition includes about 10 to about 80 wt-% active oxygen compound; about 1 to about 30 wt-% surfactant; and about 10 to about 80 wt-% builder. Preferably, the cleaning composition includes about 50 to about 70 wt-% active oxygen compound; about 7 to about 11 wt-% surfactant; and about 25 to about 35 wt-% builder. Preferably, the cleaning composition includes about 40 to about 80 wt-% active oxygen compound; about 4 to about 15 wt-% surfactant; and about 15 to about 45 wt-% builder. Preferably, the cleaning composition includes about 50 to about 60 wt-% active oxygen compound; about 8 to about 10 wt-% surfactant; and about 25 to about 30 wt-% builder. Preferably, the cleaning composition includes about 70 to about 95 wt-% active oxygen compound; about 1 to about 15 wt-% surfactant; and about 5 to about 30 wt-% builder. Preferably, the cleaning composition includes about 5 to about 30 wt-% active oxygen compound; about 1 to about 15 wt-% surfactant; and about 55 to about 95 wt-% builder. Preferably, the cleaning composition includes about 50 to about 80 wt-% active oxygen compound; about 1 to about 15 wt-% surfactant; and about 15 to about 55 wt-% builder. Preferably, the cleaning composition includes about 50 to about 60 wt-% active oxygen compound; about 6 to about 10 wt-% surfactant; and about 15 to about 25 wt-% builder. Preferably, the cleaning composition includes about 60 to about 80 wt-% active oxygen compound; about 6 to about 10 wt-% surfactant; and about 20 to about 30 wt-% builder. Preferably, the cleaning composition includes about 60 to about 80 wt-% active oxygen compound; about 1 to about 3 wt-% surfactant; and about 15 to about 25 wt-% builder. Preferably, the cleaning composition includes about 50 to about 60 wt-% active oxygen compound; about 1 to about 3 wt-% surfactant; and about 30 to about 40 wt-% builder.

Preferably, the cleaning composition includes about 40 to about 90 wt-% active oxygen compound; about 1 to about 11 wt-% surfactant; and about 20 to about 60 wt-% builder. Preferably, the cleaning composition includes about 50 to about 80 wt-% active oxygen compound; about 5 to about 11 wt-% surfactant; and about 20 to about 35 wt-% builder. Preferably, the cleaning composition includes about 80 wt-% active oxygen compound; about 2 wt-% surfactant; and about 18 wt-% builder. Preferably, the cleaning composition includes about 50 to about 70 wt-% active oxygen compound; about 1 to about 5 wt-% surfactant; and about 20 to about 40 wt-% builder. Preferably, the cleaning composition includes about 55 wt-% active oxygen compound; about 8 wt-% surfactant; and about 20 wt-% builder. Preferably, the cleaning composition includes about 50 to about 60 wt-% active oxygen compound; about 8 to about 10 wt-% surfactant; and about 25 to about 30 wt-% builder. Preferably, the cleaning composition includes about 60 to about 80 wt-% active oxygen compound; about 6 to about 10 wt-% surfactant; and about 20 to about 30 wt-% builder. Preferably, the cleaning composition includes about 50 to about 60 wt-% active oxygen compound; about 1 to about 3 wt-% surfactant; and about 30 to about 40 wt-% builder. Preferably, the cleaning composition includes about 50 to about 70 wt-% active oxygen compound; about 7 to about 11 wt-% surfactant; and about 25 to about 35 wt-% builder.

Preferably, the cleaning composition includes about 5-15% phosphonate; about 15-25% condensed phosphate; about 5-10% nonionic surfactant; about 55-65% hydrogen peroxide adduct. Preferably, the cleaning composition includes about 5-10% aminocarboxylate; about 5-10% nonionic surfactant; about 15-25% alkali metal carbonate; about 10-15% carboxylic acid; about 50-60% hydrogen peroxide adduct. Preferably, the cleaning composition includes about 5-15% aminocarboxylate; about 1-5% nonionic surfactant; about 10-30% alkali metal carbonate, alkali metal bicarbonate, or mixtures thereof; and about 50-90% hydrogen peroxide adduct. Preferably, the cleaning composition includes about 50 to about 80 wt-% sodium percarbonate; about 1 to about 11 wt-% alcohol ethoxylate, alkylbenzene sulfonate, or mixtures thereof; and about 20 to about 40 wt-% non-phosphate builder.

Preferably, the cleaning composition includes nonionic surfactant, phosphonate, condensed phosphate, hydrogen peroxide adduct, C1-C6 carboxylic acid, alkali metal hydrogen carbonate, alkali metal hydrogen phosphate, alkali metal hydrogen sulfate, or combinations thereof. Preferably, the cleaning composition includes nonionic surfactant, aminocarboxylate, hydrogen peroxide adduct, C1-C6 carboxylic acid, alkali metal hydrogen carbonate, alkali metal hydrogen phosphate, alkali metal hydrogen sulfate, or combinations thereof.

Solid or agglomerate cleaning compositions that can be employed in the present carpet and upholstery cleaning or sanitizing methods include those described in U.S. patent application Ser. No. ______ filed Jun. 5, 2001 and entitled SOLID CLEANING COMPOSITION INCLUDING STABILIZED OXYGEN BLEACH COMPONENT and in U.S. Provisional Patent Application Serial No. ______ filed evendate herewith and entitled SOLID CLEANING COMPOSITION INCLUDING STABILIZED OXYGEN BLEACH COMPONENT. The disclosures of each of these two patent applications is incorporated herein by reference.

Active Oxygen Compound

The active oxygen compound acts to provide a source of active oxygen and stain bleaching, and also, preferably, provides antimicrobial action. The active oxygen compound can be inorganic or organic, and can be a mixture thereof. Some examples of active oxygen compound include peroxygen compounds, and peroxygen compound adducts.

Many active oxygen compounds are peroxygen compounds. Any peroxygen compound generally known, and that preferably can provide antimicrobial action, can be used. Examples of suitable peroxygen compounds include inorganic and organic peroxygen compounds, or mixtures thereof.

Inorganic Active Oxygen Compounds

Examples of inorganic active oxygen compounds include the following types of compounds or sources of these compounds, or alkali metal salts including these types of compounds, or forming an adduct therewith:

hydrogen peroxide;

group 1 (IA) active oxygen compounds, for example lithium peroxide, sodium peroxide, and the like;

group 2 (IIA) active oxygen compounds, for example magnesium peroxide, calcium peroxide, strontium peroxide, barium peroxide, and the like;

group 12 (IIB) active oxygen compounds, for example zinc peroxide, and the like;

group 13 (IIIA) active oxygen compounds, for example boron compounds, such as perborates, for example sodium perborate hexahydrate of the formula Na₂[Br₂(O₂)₂(OH)₄]. 6H₂O (also called sodium perborate tetrahydrate and formerly written as NaBO₃.4H₂O); sodium peroxyborate tetrahydrate of the formula Na₂Br₂(O₂)₂[(OH)₄].4H₂O (also called sodium perborate trihydrate, and formerly written as NaBO₃.3H₂O); sodium peroxyborate of the formula Na₂[B₂(O₂)₂(OH)₄] (also called sodium perborate monohydrate and formerly written as NaBO₃.H₂O); and the like; preferably perborate;

group 14 (IVA) active oxygen compounds, for example persilicates and peroxycarbonates, which are also called percarbonates, such as persilicates or peroxycarbonates of alkali metals; and the like; preferably percarbonate;

group 15 (VA) active oxygen compounds, for example peroxynitrous acid and its salts; peroxyphosphoric acids and their salts, for example, perphosphates; and the like; preferably perphosphate;

group 16 (VIA) active oxygen compounds, for example peroxysulfuric acids and their salts, such as peroxymonosulfuric and peroxydisulfuric acids, and their salts, such as persulfates, for example, sodium persulfate; and the like; preferably persulfate;

group VIIa active oxygen compounds such as sodium periodate, potassium perchlorate and the like.

Other active inorganic oxygen compounds can include transition metal peroxides; and other such peroxygen compounds, and mixtures thereof.

Preferably, the compositions and methods of the present invention employ certain of the inorganic active oxygen compounds listed above. Preferred inorganic active oxygen compounds include hydrogen peroxide, hydrogen peroxide adduct, group IIIA active oxygen compound group, VIA active oxygen compound, group VA active oxygen compound, group VIIA active oxygen compound, or mixtures thereof. Preferred examples of such inorganic active oxygen compounds include percarbonate, perborate, persulfate, perphosphate, persilicate, or mixtures thereof. Hydrogen peroxide presents one preferred example of an inorganic active oxygen compound. Hydrogen peroxide can be formulated as a mixture of hydrogen peroxide and water, e.g., as liquid hydrogen peroxide in an aqueous solution. The mixture of solution can include about 5 to about 40 wt-% hydrogen peroxide, preferably 5 to 50 wt-% hydrogen peroxide.

In an embodiment, the preferred inorganic active oxygen compounds include hydrogen peroxide adduct. For example, the inorganic active oxygen compounds can include hydrogen peroxide, hydrogen peroxide adduct, or mixtures thereof. Any of a variety of hydrogen peroxide adducts are suitable for use in the present compositions and methods. For example, suitable hydrogen peroxide adducts include alkali metal percarbonate salt, urea peroxide, peracetyl borate, an adduct of H₂O₂ and polyvinyl pyrrolidone, sodium percarbonate, potassium percarbonate, mixtures thereof, or the like. Preferred hydrogen peroxide adducts include percarbonate salt, urea peroxide, peracetyl borate, an adduct of H₂O₂ and polyvinyl pyrrolidone, or mixtures thereof. Preferred hydrogen peroxide adducts include sodium percarbonate, potassium percarbonate, or mixtures thereof, preferably sodium percarbonate.

Active Oxygen Compound Adducts

Active oxygen compound adducts include any generally known, and that preferably can function as a source of active oxygen and as part of the solid or agglomerate composition. Hydrogen peroxide adducts, or peroxyhydrates, are preferred. Some examples of active oxygen compound adducts include the following:

alkali metal percarbonates, for example sodium percarbonate (sodium carbonate peroxyhydrate), potassium percarbonate, rubidium percarbonate, cesium percarbonate, and the like; ammonium carbonate peroxyhydrate, and the like; urea peroxyhydrate, peroxyacetyl borate; an adduct of H₂O₂ polyvinyl pyrrolidone, and the like, and mixtures of any of the above.

Alkali metal percarbonates are preferred, with sodium percarbonate being the most preferred. However, it should be noted that in some embodiments, as illustrated in the examples, the active oxygen compound does not include sodium percarbonate.

Organic Active Oxygen Compounds

Any of a variety of organic active oxygen compounds can be employed in the compositions and methods of the present invention. For example, the organic active oxygen compound can be a peroxycarboxylic acid, such as a mono- or di-peroxycarboxylic acid or an ester peroxycarboxylic acid, an alkali metal salt including these types of compounds, or an adduct of such a compound. Preferred peroxycarboxylic acids include C₁-C₂₄ peroxycarboxylic acid, salt of C₁-C₂₄ peroxycarboxylic acid, ester of C₁-C₂₄ peroxycarboxylic acid, diperoxycarboxylic acid, salt of diperoxycarboxylic acid, ester of diperoxycarboxylic acid, or mixtures thereof.

Preferred peroxycarboxylic acids include C₁-C₁₀ aliphatic peroxycarboxylic acid, salt of C₁-C₁₀ aliphatic peroxycarboxylic acid, ester of C₁-C₁₀ aliphatic peroxycarboxylic acid, or mixtures thereof; preferably salt of or adduct of peroxyacetic acid; preferably peroxyacetyl borate. Preferred diperoxycarboxylic acids include C₄-C₁₀ aliphatic diperoxycarboxylic acid, salt of C₄-C₁₀ aliphatic diperoxycarboxylic acid, or ester of C₄-C₁₀ aliphatic diperoxycarboxylic acid, or mixtures thereof; preferably a sodium salt of perglutaric acid, of persuccinic acid, of peradipic acid, or mixtures thereof.

Organic active oxygen compounds include other acids including an organic moiety. Preferred organic active oxygen compounds include perphosphonic acids, perphosphonic acid salts, perphosphonic acid esters, or mixtures or combinations thereof.

Ester Peroxycarboxylic Acids

As used herein, ester peroxycarboxylic acid refers to a molecule having the formula:

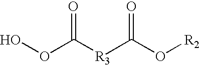

In this formula, R₂ and R₃ can independently be any of a wide variety of organic groups (e.g. alkyl, linear or cyclic, aromatic or saturated) or substituted organic groups (e.g., with one or more heteroatoms or organic groups). Ester peroxycarboxylic acid can be made using methods typically employed for producing peroxycarboxylic acid, such as incubating the corresponding monoester (described later) or diester (previously described) dicarboxylate with hydrogen peroxide. Ester peroxycarboxylic acids derived from or corresponding to the mono- or diester dicarboxylates described herein are preferred.

Preferred ester peroxycarboxylic acids include alkyl ester peroxycarboxylic acids, preferably having the formula:

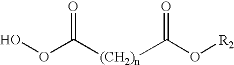

where R₂ represents an alkyl group having from 1 to 8 carbons and n is 0 to 6, preferably 1 to 5. The alkyl group can be either straight chain or branched. Preferably, R₂ is a methyl, ethyl, propyl (n-, iso-), butyl (n-, iso-, tert-), n-amyl, n-hexyl, or 2-ethylhexyl group. Preferably, n is 2, 3, 4, or 5. In one preferred embodiment, the composition of or employed in the present invention includes a mixture of alkyl ester peroxycarboxylic acids in which n is 2, 3, and 4. Such a mixture includes monoesters of peroxyadipic, peroxyglutaric, and peroxysuccinic acids. In another preferred embodiment, a majority of the ester peroxycarboxylic acid in the composition has x equal to 3. In a preferred embodiment, R₂ is a C₁-C₈ alkyl. In a preferred embodiment, n is 1, 2, 3, or 4. Most preferably, R₂ is a C₁ alkyl, C₂ alkyl, C₃ alkyl, or C₄ alkyl, and n is 2, 3 or 4, or a combination thereof. In another most preferred embodiment, R₂ is a C₅-C₈ alkyl, n is 5 or 6.

Alkyl ester peroxycarboxylic acids useful in this invention include monomethyl monoperoxyoxalic acid, monomethyl monoperoxymalonic acid, monomethyl monoperoxysuccinic acid, monomethyl monoperoxyglutaric acid, monomethyl monoperoxyadipic acid, monomethyl monoperoxysebacic acid; monoethyl monoperoxyoxalic acid, monoethyl monoperoxymalonic acid, monoethyl monoperoxysuccinic acid, monoethyl monoperoxyglutaric acid, monoethyl monoperoxyadipic acid, monoethyl monoperoxysebacic acid; monopropyl monoperoxyoxalic acid, monopropyl monoperoxymalonic acid, monopropyl monoperoxysuccinic acid, monopropyl monoperoxyglutaric acid, monopropyl monoperoxyadipic acid, monopropyl monoperoxysebacic acid, in which propyl can be n- or iso-propyl; monobutyl monoperoxyoxalic acid, monobutyl monoperoxymalonic acid, monobutyl monoperoxysuccinic acid, monobutyl monoperoxyglutaric acid, monobutyl monoperoxyadipic acid, monobutyl monoperoxysebacic acid, in which butyl can be n-, iso-, or t-butyl; monoamyl monoperoxyoxalic acid, monoamyl monoperoxymalonic acid, monoamyl monoperoxysuccinic acid, monoamyl monoperoxyglutaric acid, monoamyl monoperoxyadipic acid, monoamyl monoperoxysebacic acid, in which amyl is n-; monohexyl monoperoxysebacic acid, in which hexyl is n-; mono-2-ethylhexyl monoperoxysebacic acid.

Peroxycarboxylic Acids

Peroxycarboxylic (or percarboxylic) acids generally have the formula R(CO₃H)ₙ, where R is an alkyl, arylalkyl, cycloalkyl, aromatic, heterocyclic, or ester group, such as an alkyl ester group; and n is one, two, or three, and named by prefixing the parent acid with peroxy. Ester groups are defined as R groups including organic moieties (such as those listed above for R) and ester moieties. Preferred ester groups include aliphatic ester groups, such as R₁OC(O)R₂—where each of R₁ and R₂ can be aliphatic, preferably alkyl, groups described above for R. Preferably R₁ and R₂ are each independently small alkyl groups, such as alkyl groups with 1 to 8 carbon atoms.

While peroxycarboxylic acids are not as stable as carboxylic acids, their stability generally increases with increasing molecular weight. Thermal decomposition of these acids can generally proceed by free radical and nonradical paths, by photodecomposition or radical-induced decomposition, or by the action of metal ions or complexes. Percarboxylic acids can be made by the direct, acid catalyzed equilibrium action of hydrogen peroxide with the carboxylic acid, by autoxidation of aldehydes, or from acid chlorides, and hydrides, or carboxylic anhydrides with hydrogen or sodium peroxide.

Peroxycarboxylic acids useful in the compositions and methods of the present invention include peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxycitric, peroxymaleic, peroxyascorbic, peroxyhydroxyacetic (peroxyglycolic), peroxyoxalic, peroxymalonic, peroxysuccinic, peroxyglutaric, peroxyadipic, peroxypimelic and peroxysubric acid and mixtures thereof. Useful peroxycarboxylic acids also include the ester peroxycarboxylic acids described hereinabove.

Peroxy forms of carboxylic acids with more than one carboxylate moiety can have one or more of the carboxyl moieties present as peroxycarboxyl moieties. These peroxycarboxylic acids and their alkali metal salts have been found to provide good antimicrobial action with good stability in aqueous mixtures. In a preferred embodiment, the composition of or employed in the invention utilizes a combination of several different peroxycarboxylic acids.

In preferred embodiment, the composition includes one or more alkyl ester peroxycarboxylic acids and, optionally, a peroxycarboxylic acid having from 2 to 12 carbon atoms. Preferably, such a composition includes peroxyacetic acid, or peroxyoctanoic acid, or peroxydecanoic acid, and monomethyl monoperoxyoxalic acid, monomethyl monoperoxymalonic acid, monomethyl monoperoxysuccinic acid, monomethyl monoperoxyglutaric acid, monomethyl monoperoxyadipic acid; monoethyl monoperoxyoxalic acid, monoethyl monoperoxymalonic acid, monoethyl monoperoxysuccinic acid, monoethyl monoperoxyglutaric acid, monoethyl monoperoxyadipic acid; monopropyl monoperoxyoxalic acid, monopropyl monoperoxymalonic acid, monopropyl monoperoxysuccinic acid, monopropyl monoperoxyglutaric acid, monopropyl monoperoxyadipic acid, in which propyl can be n- or isopropyl; monobutyl monoperoxyoxalic acid, monobutyl monoperoxymalonic acid, monobutyl monoperoxysuccinic acid, monobutyl monoperoxyglutaric acid, monobutyl monoperoxyadipic acid, in which butyl can be n-, iso-, or tert-butyl; monoamyl oxalic acid, monoamyl malonic acid, monoamyl succinic acid, monoamyl glutaric acid, monoamyl adipic acid, monoamyl sebacic acid, in which amyl is n-; monohexyl sebacic acid, in which hexyl is n-; and mono-2-ethylhexyl sebacic acid, or mixtures thereof.

Compositions Including Active Oxygen Compound

In certain embodiments, the cleaning composition includes about 10 to about 80 wt-% active oxygen compound; about 50 to about 80 wt-% active oxygen compound; about 40 to about 80 wt-% active oxygen compound; about 50 to about 70 wt-% active oxygen compound; about 50 to about 65 wt-% active oxygen compound; about 50 to about 60 wt-% active oxygen compound; about 60 to about 80 wt-% active oxygen compound; about 60 to about 90 wt-% active oxygen compound; about 70 to about 95 wt-% active oxygen compound; about 80 to about 90 wt-% active oxygen compound; or about 5 to about 30 wt-% active oxygen compound.

In certain embodiments, the cleaning composition includes about 40 to about 90 wt-% active oxygen compound; about 50 to about 80 wt-% active oxygen compound; about 60 to about 80 wt-% active oxygen compound; about 50 to about 70 wt-% active oxygen compound; about 50 to about 60 wt-% active oxygen compound; about 80 wt-% active oxygen compound; or about 55 wt-% active oxygen compound.

In certain embodiments, the cleaning composition includes as a lower limit about 10, about 20, about 30, about 40, about 50, about 60, about 70, or about 80 wt-% active oxygen compound up to an upper limit of about 20, about 30, about 40, about 50, about 60, about 70, about 80, or about 90 wt-% active oxygen compound, or each of these end points not modified by about. In certain embodiments, the cleaning composition includes about 30, about 40, about 50, about 55, about 60, about 65, about 70, about 75, about 80, about 85, about 90 wt-% active oxygen compound, or any of these amounts not modified by about.

Surfactant

The composition can include at least one cleaning agent which is preferably a surfactant or surfactant system. A variety of surfactants, or mixtures of surfactants, can be employed. Suitable surfactants include anionic, nonionic, and zwitterionic surfactants, which are commercially available from a number of sources. Preferred surfactants include nonionic surfactants. For a discussion of surfactants, see Kirk-Othmer, Encyclopedia of Chemical Technology, Third Edition, volume 8, pages 900-912.

Anionic surfactants useful in the present cleaning compositions, include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Preferred anionics are sodium alkylarylsulfonate, alpha-olefin sulfonate, and fatty alcohol sulfates. Examples of preferred anionic surfactants include sodium dodecylbenzene sulfonic acid, potassium laureth-7 sulfate, and sodium tetradecenyl sulfonate.

Nonionic surfactants are useful in the present cleaning compositions, include those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and ethoxylated amines and ether amines commercially available from Tomah Corporation and other like nonionic compounds. Silicone surfactants such as the ABIL B8852 (Goldschmidt) can also be used.

Additional suitable nonionic surfactants having a polyalkylene oxide polymer portion include nonionic surfactants of C6-C24 alcohol ethoxylates (preferably C6-C14 alcohol ethoxylates) having 1 to about 20 ethylene oxide groups (preferably about 9 to about 20 ethylene oxide groups); C6-C24 alkylphenol ethoxylates (preferably C8-C10 alkylphenol ethoxylates) having 1 to about 100 ethylene oxide groups (preferably about 12 to about 20 ethylene oxide groups); C6-C24 alkylpolyglycosides (preferably C6-C20 alkylpolyglycosides) having 1 to about 20 glycoside groups (preferably about 9 to about 20 glycoside groups); C6-C24 fatty acid ester ethoxylates, propoxylates or glycerides; and C4-C24 mono or dialkanolamides.

Specific alcohol alkoxylates include alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; and polyalkylene oxide block copolymers including an ethylene oxide/propylene oxide block copolymer such as those commercially available under the trademark PLURONIC (BASF-Wyandotte), and the like.

Preferred nonionic surfactants, particularly for carpet or upholstery cleaning or sanitizing, include low foaming nonionic surfactants. Although, higher foaming nonionic surfactants can be employed in the compositions and methods of the present invention. Examples of preferred, low foaming, nonionic surfactants include secondary ethoxylates, such as those sold under the trade name TERGITOL™, such as TERGITOL™ 15-S-7 (Union Carbide), Tergitol 15-S-3, Tergitol 15-S-9 and the like. Other preferred classes of low foaming nonionic surfactant include alkyl or benzyl-capped polyoxyalkylene derivatives and polyoxyethylene/polyoxypropylene copolymers.

A useful nonionic surfactant for use as a defoamer is nonylphenol having an average of 12 moles of ethylene oxide condensed thereon, it being end capped with a hydrophobic portion comprising an average of 30 moles of propylene oxide. Silicon-containing defoamers are also well-known and can be employed in the compositions and methods of the present invention.

Preferred amphoteric surfactants include amine oxide compounds having the formula:

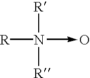

where R, R′, R″, and R′″ are each a C₁-C₂₄ alkyl, aryl or aralkyl group that can optionally contain one or more P, O, S or N heteroatoms.

Another class of preferred amphoteric surfactants includes betaine compounds having the formula:

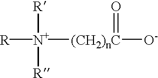

where R, R′, R″ and R′″ are each a C₁-C₂₄ alkyl, aryl or aralkyl group that can optionally contain one or more P, O, S or N heteroatoms, and n is about 1 to about 10.

Preferred surfactants include food grade surfactants, linear alkylbenzene sulfonic acids and their salts, and ethylene oxide/propylene oxide derivatives sold under the Pluronic™ trade name. A preferred surfactant is compatible as an indirect or direct food additive or substance; especially those described in the Code of Federal Regulations (CFR), Title 21—Food and Drugs, parts 170 to 186 (which is incorporated herein by reference).

Compositions for carpet or upholstery cleaning or sanitizing preferably include a low foam surfactant such as a nonionic surfactant or a combination of an anionic surfactant with a defoamer. An amphoteric surfactant can be employed for carpet or upholstery cleaning or sanitizing compositions, but such surfactants typically produce undesirably high levels of foam. Compositions for carpet or upholstery cleaning or sanitizing preferably do not employ a cationic surfactant, use of which can void warranties provided by certain carpet or upholstery manufacturers, which is believed to be due to their action as an attractant for anionic soils.

Usually, solid or agglomerate cleaning compositions for carpet or upholstery cleaning according to the present invention will contain no more than about 25 wt-% surfactant, preferably about 0.1-20 wt-%, preferably about 1.5-15 wt-%, preferably 0.1 to about 10 wt-% surfactant, and most preferably 0.1 to about 5 wt-% surfactant. Use dilutions of these concentrates preferably contain no more than about 10 wt-% surfactant, more preferably 0.1 to about 5 wt-% surfactant, and most preferably 0.1 to about 2 wt-%.

Compositions Including Surfactant

In certain embodiments, the cleaning composition includes about 1 to about 30 wt-% surfactant; about 1 to about 15 wt-% surfactant; about 1 to about 5 wt-% surfactant; about 1 to about 4 wt-% surfactant; about 1 to about 3 wt-% surfactant; about 4 to about 15 wt-% surfactant; about 6 to about 10 wt-% surfactant; about 7 to about 11 wt-% surfactant; or about 8 to about 10 wt-% surfactant. In certain embodiments, the cleaning composition includes about 1 to about 11 wt-% surfactant; about 1 to about 5 wt-% surfactant; about 1 to about 3 wt-% surfactant; about 5 to about 11 wt-% surfactant; about 6 to about 10 wt-% surfactant; about 7 to about 11 wt-% surfactant; about 8 to about 10 wt-% surfactant; or about 8 wt-% surfactant.

In certain embodiments, the cleaning composition includes as a lower limit about 1, about 2, about 3, about 4, about 5, about 6, about 7, about 8, about 10, about 15, about 20, or about 25 wt-% surfactant up to an upper limit of about 2, about 3, about 4, about 5, about 6, about 7, about 8, about 10, about 11, about 15, about 20, or about 25 wt-% surfactant, or each of these endpoints not modified by about. In certain embodiments, the cleaning composition includes about 1, about 2, about 3, about 4, about 5, about 6, about 7, about 8, about 9, or about 10, about 11, about 15, about 20, about 25, or about 30 wt-% surfactant, or any of these amounts not modified by about.

Builder

Builders can be included in the cleaning compositions for the present invention for purposes including assisting in controlling mineral hardness. Builders include cheating agents (chelators), sequestering agents (sequestrants), detergent builders, and the like. Inorganic as well as organic builders can be used. The builder can also function as a threshold agent when included in an effective amount. Preferably, the level of chelating agent builder is sufficient to prevent precipitation in hard water. The level of builder can vary widely depending upon the end use of the composition and its desired physical form. Preferably, a cleaning composition includes about 1-99 wt-%, preferably about 10-80 wt-%, preferably about 15-65 wt-% of one or more builders, e.g., one or more builders, chelating agents (chelators), or sequestering agents (sequestrants).

Builders, chelating agents, or sequestrants generally useful in the present compositions include alkyl diamine polyacetic acid-type chelating agents such as EDTA (ethylene diamine tetraacetate tetrasodium salt), acrylic and polyacrylic acid-type stabilizing agents, phosphonic acid, and phosphonate-type chelating agents, aminocarboxylic acids, condensed phosphates, polymeric polycarboxylates, iminodisuccinates, and the like.

Preferred sequestrants include phosphonic acids and phosphonate salts including 1-hydroxy ethylidene-1,1-diphosphonic acid (CH₃C(PO₃H₂)₂OH) (HEDP), amino[tri(methylene phosphonic acid)] (ATMP), ethylene diamine[tetra methylene-phosphonic acid)], 2-phosphene butane-1,2,4-tricarboxylic acid (PBTC), as well as the alkyl metal salts, ammonium salts, or alkyloyl amine salts, such as mono, di, or tetra-ethanolamine salts.

Organic phosphonates suitable for use as a builder in the present compositions and methods include those that are suitable for use with the active oxygen compound. Organic phosphonates include organic-phosphonic acids, and alkali metal salts thereof. Some examples of suitable organic phosphonates include: 1-hydroxyethane-1,1-diphosphonic acid: CH₃C(OH)[PO(OH)₂]₂; aminotri(methylenephosphonic acid): N[CH₂PO(OH)₂]₃; aminotri(methylenephosphonate), sodium salt

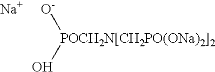

2-hydroxyethyliminobis(methylenephosphonic acid): HOCH₂CH₂N[CH₂PO(OH)₂]₂; diethylenetriaminepenta(methylenephosphonic acid): (HO)₂POCH₂N[CH₂CH₂N[CH₂PO(OH)₂]₂]₂; diethylenetriaminepenta(methylenephosphonate), sodium salt: C₉H₍₂₈₋ₓ₎N₃NaₓO₁₅P₅(x−7); hexamethylenediamine(tetramethylenephosphonate), potassium salt: C₁₀H₍₂₈₋ₓ₎N₂KₓO₁₂P₄ (x=6); bis(hexamethylene)triamine(pentamethylenephosphonic acid): (HO₂)POCH₂N[(CH₂)₆N[CH₂PO(OH)₂]₂]₂; and phosphorus acid H₃PO₃; organic phosphonates, and mixtures thereof.

A preferred organic phosphonate combination is ATMP and DTPMP. A neutralized or alkaline phosphonate, or a combination of the phosphonate with an alkali source prior to being added into the mixture such that there is little or no heat or gas generated by a neutralization reaction when the phosphonate is added is preferred.

The phosphonic acid or phosphonate can include a low molecular weight phosphonopolycarboxylic acid such as one having about 2-4 carboxylic acid moieties and about 1-3 phosphonic acid groups. Such acids include 1-phosphono-1-methylsuccinic acid, phosphonosuccinic acid and 2-phosphonobutane-1,2,4-tricarboxylic acid.

Commercially available chelating agents include phosphonates sold under the trade name DEQUEST® including, for example, 1-hydroxyethylidene-1,1-diphosphonic acid, available from Monsanto Industrial Chemicals Co., St. Louis, Mo., as DEQUEST® 2010; amino(tri(methylenephosphonic acid)), (N[CH₂PO₃H₂]₃), available from Monsanto as DEQUEST® 2000; ethylenediamine[tetra(methylenephosphonic acid)] available from Monsanto as DEQUEST® 2041; and 2-phosphonobutane-1,2,4-tricarboxylic acid available from Mobay Chemical Corporation, Inorganic Chemicals Division, Pittsburgh, Pa., as Bayhibit AM; and amino[tri(methylene phosphonic acid)] (ATMP) available as Briquest 301-50A: Amino Tri (Methylene Phosphonic Acid) (ATMP), 50%, low ammonia from Albright & Wilson.

Above-mentioned phosphonic acids can also be used in the form of water soluble acid salts, particularly the alkali metal salts, such as sodium or potassium; the ammonium salts or the alkylol amine salts where the alkylol has 2 to 3 carbon atoms, such as mono-, di-, or triethanolamine salts. If desired, mixtures of the individual phosphonic acids or their acid salts can also be used.

Amino phosphates and phosphonates are suitable for use as chelating agents in the compositions of or employed in the invention and include ethylene diamine (tetramethylene phosphonates), nitrilotrismethylene phosphates, diethylenetriamine (pentamethylene phosphonates). These amino phosphonates commonly contain alkyl or alkaline groups with less than 8 carbon atoms. Examples of suitable amino phosphonates include:

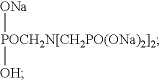

2-hydroxyethyliminobis(methylenephosphonic acid) HOCH₂CH₂N[CH₂PO(OH)₂]₂; diethylenetriaminepenta(methylenephosphonic acid) (HO)₂POCH₂N[CH₂CH₂N[CH₂PO(OH)₂]₂]₂; diethylenetriaminepenta(methylenephosphonate), sodium salt C₉H₍₂₈₋ₓ₎N₃NaₓO₁₅P₅(x=7); hexamethylenediamine(tetramethylenephosphonate), potassium salt C₁₀H₂₈₋ₓ₎N₂KₓO₁₂P₄ (x=6); bis(hexamethylene)triamine(pentamethylenephosphonic acid) (HO₂)POCH₂N[(CH₂)₆N[CH₂PO(OH)₂]₂]₂.

The organic sequestrant can also include aminocarboxylic acid type sequestrant. Aminocarboxylic acid type sequestrant can include the acids, or alkali metal salts thereof. Examples of aminocarboxylic acid materials include amino acetates and salts thereof. Suitable amino carboxylates include: N-hydroxyethylaminodiacetic acid; hydroxyethylenediaminetetraacetic acid, nitrilotriacetic acid (NTA); ethylenediaminetetraacetic acid (EDTA); N-hydroxyethyl-ethylenediaminetriacetic acid (BEDTA); diethylenetriaminepentaacetic acid (DTPA); and alanine-N,N-diacetic acid; n-hydroxyethyliminodiacetic acid; and the like; and mixtures thereof.

Inorganic or phosphate-containing detergent builders include alkali metal, ammonium and alkanolammonium salts of polyphosphates (e.g. tripolyphosphates, pyrophosphates, and glassy polymeric meta-phosphates). Suitable condensed phosphates include sodium and potassium orthophosphate, sodium and potassium pyrophosphate, sodium and potassium tripolyphosphate, sodium hexametaphosphate, and the like. A condensed phosphate can also assist, to a limited extent, in solidification of the composition by fixing the free water present in the composition as water of hydration.

Non-phosphate builders can also be used. These can include aminocarboxylates, silicates, alkali metal carbonates (e.g. carbonates, bicarbonates, and sesquicarbonates), sulfates, aluminosilicates, monomeric polycarboxylates, homo or copolymeric polycarboxylic acids or their salts in which the polycarboxylic acid includes at least two carboxylic radicals separated from each other by not more than two carbon atoms, citrates, succinates, iminodisuccinates, and the like. Preferred aminocarboxylates include ethylenediamine tetraacetic acid (EDTA), diethylenetriamine pentaacetic acid (DTPA), their alkali metal salts, and mixtures thereof. Preferred builders include water soluble nonphosphorus-containing compounds such as aminocarboxylates, nitrilotriacetic acid and its alkali metal salts, and also citrate builders, e.g., citric acid and soluble salts thereof, and mixtures thereof. Such builders can enhance detergency of a soap or detergent solution, are typically availability from renewable resources, and are generally biodegradability. Preferred mixtures include a mixture of aminocarboxylate builder and citric acid or citrate builder.

Suitable polycarboxylates include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

Preferred compositions for carpet or upholstery cleaning or sanitizing include as a builder, chelating agent, or sequestrant a condensed phosphate, phosphonate, aminocarboxylate, citric acid or citrate salt, and/or alkali metal carbonate or mixtures thereof. Preferred condensed phosphates include sodium tripolyphosphate. Preferred compositions for carpet or upholstery cleaning or sanitizing include as a builder, chelating agent, or sequestrant aminocarboxylate, citric acid or alkali metal citrate salt, alkali metal carbonate, or mixtures thereof.

Preferably, the cleaning composition includes as builder zeolite, citric or citrate-type chelating agent, alkyl diamine polyacetic acid-type chelating agent, acrylic or polyacrylic acid-type stabilizing agent, phosphonic acid or phosphonate-type chelating agent, aminocarboxylic acid, condensed phosphate, polymeric polycarboxylate, or a mixture thereof.

Preferably, the cleaning composition includes as builder phosphonate and the phosphonate includes amino tri(methylene phosphonic) acid; 1-hydroxyethylidene-1,1-diphosphonic acid; diethylenetriaminopenta(methylene phosphonic) acid; alanine-N,N-diacetic acid; diethylenetriaminepentaacetic acid; salts thereof; or mixtures thereof.

Preferably, the cleaning composition includes as builder condensed phosphate and the condensed phosphate includes sodium tripolyphosphate, potassium tripolyphosphate, magnesium tripolyphosphate, sodium pyrophosphate, potassium pyrophosphate, sodium hexametaphosphate, potassium hexametaphosphate, or a mixture thereof.

Preferably, the cleaning composition includes as builder nitrilotriacetate, citric acid, ethylene diamine tetraacetate, salt thereof, or mixture thereof.

Compositions Including Builder

In certain embodiments, the cleaning composition includes about 10 to about 80 wt-% builder; about 10 to about 40 wt-% builder; about 10 to about 20 wt-% builder; about 15 to about 55 wt-% builder; about 15 to about 45 wt-% builder; about 15 to about 25 wt-% builder; about 20 to about 35 wt-% builder; about 20 to about 30 wt-% builder; about 25 to about 35 wt-% builder; about 25 to about 30 wt-% builder; about 30 to about 40 wt-% builder; about 5 to about 30 wt-% builder; or about 55 to about 95 wt-% builder.

In certain embodiments, the cleaning composition includes about 20 to about 60 wt-% builder; about 20 to about 40 wt-% builder; about 20 to about 35 wt-% builder; about 20 to about 30 wt-% builder; about 25 to about 35 wt-% builder; about 25 to about 30 wt-% builder; about 30 to about 40 wt-% builder; about 18 wt-% builder; or about 20 wt-% builder.

In certain embodiments, the cleaning composition includes as a lower limit about 10, about 20, about 30, about 40, about 50, about 60, or about 70, wt-% builder up to an upper limit of about 20, about 30, about 40, about 50, about 60, about 70, or about 80, or about 90 wt-% builder, or each of these endpoints not modified by about. In certain embodiments, the cleaning composition includes about 10, about 15, about 20, about 25, about 30, about 35, about 40, about 45, about 50, about 65, or about 70 wt-% builder, or any of these amounts not modified by about.

Water

The solid (e.g., powder) or agglomerate compositions of or employed in the methods of the present invention can include water. Preferably, the solid (e.g., powder) or agglomerate compositions include only 0 to about 10 wt-% water. It is believed that such low concentrations of water can help maintain stability of the active oxygen component of the composition. Preferably, the solid (e.g., powder) or agglomerate composition contains only any water that forms part of the ingredients of the composition, that is, the composition is free of any added water. Preferably, the solid (e.g., powder) or agglomerate composition is substantially free of water, that is, the composition includes less than about 1 wt-% water.

Additives

Solid (e.g., powder) or agglomerate cleaning compositions of or employed in the present invention can further include additional functional materials or additives that provide a beneficial property, for example, to harden the composition in solid form or to aid in dissolution when dispersed or dissolved in an aqueous solution, e.g., for a particular use. Examples of conventional additives include one or more of each of salt or additional salt, alkalinity source, acidity source, pH buffer, hardening agent, debrowning agent, solubility modifier, detergent filler, water softener, defoamer, anti-redeposition agent, precipitation threshold agent or system, antimicrobial agent, aesthetic enhancing agent (i.e., dye, odorant, perfume), optical brightener, bleaching agent, enzyme, effervescent agent, activator for the active oxygen compound, tablet dissolution aid, other such additives or functional ingredients, and the like, and mixtures thereof. Adjuvants and other additive ingredients will vary according to the type of composition being manufactured, and the intended end use of the composition.

Preferably, the composition includes as an additive one or more of alkalinity source, acidity source, cleaning enzyme, hardening agent, solubility modifier, detergent filler, defoamer, antimicrobial agent, a precipitation threshold agent or system, aesthetic enhancing agent, effervescent agent, activator for the active oxygen compound, or combinations thereof. Preferably, the composition includes as an additive one or more of source of alkalinity, cleaning enzyme, antimicrobial, activators for the active oxygen compound, or mixtures thereof.

Preferably, the cleaning composition includes nonionic surfactant, phosphonate, condensed phosphate, hydrogen peroxide adduct, C1-C6 carboxylic acid, alkali metal hydrogen carbonate, alkali metal hydrogen phosphate, alkali metal hydrogen sulfate, or combinations thereof. Preferably, the cleaning composition includes nonionic surfactant, aminocarboxylate, hydrogen peroxide adduct, C1-C6 carboxylic acid, alkali metal hydrogen carbonate, alkali metal hydrogen phosphate, alkali metal hydrogen sulfate, or combinations thereof.

Salts

Some embodiments of the cleaning composition optionally include salt, or one or more additional salts, for example, alkali metal salt. The alkali metal salt can act as an alkalinity source to enhance cleaning of a substrate, and improve soil removal performance of the composition.

Additionally, in some embodiments the alkali metal salts can provide for the formation of an additional binder complex or binding agent including: alkali metal salt; organic sequestrant including a phosphonate, an aminocarboxylic acid, or mixtures thereof; and water. We refer to such binder complexes as “E-Form” hydrates. Such E-Form hydrates are discussed in detail in the following U.S. Patents and patent applications: U.S. Pat. Nos. 6,177,392 B1; 6,150,324; and 6,156,715; and U.S. patent application Ser. No. 08/989,824; each of which is incorporated herein by reference. The binding agent can include the organic sequestrant and the active oxygen compound. Preferably the binding agent has melting transition temperature in the range of about 120° C. to 160° C.

Some examples of alkali metal salts include alkali metal carbonates, silicates, phosphates, phosphonates, sulfates, borates, or the like, and mixtures thereof. Alkali metal carbonates are more preferred, and some examples of preferred carbonate salts include alkali metal carbonates such as sodium or potassium carbonate, bicarbonate, sesquicarbonate, mixtures thereof, and the like; preferably sodium carbonate, potassium carbonate, or mixtures thereof.

In an embodiment, the active oxygen compound and the salt include a single preformed ingredient prior to addition to the mixture. Preferably, in such an embodiment, the active oxygen compound and the salt together include a hydrogen peroxide adduct. However, in a preferred version of such an embodiment, at least a portion of the salt is a separate ingredient from the active oxygen compound prior to addition to the mixture.

The composition can include in the range of 0 to about 80 wt-%, preferably about 15 to about 70 wt-% of an alkali metal salt, most preferably about 20 to about 60 wt-%.

Additionally, in some embodiments, salts, for example acidic salts, can be included as pH modifiers, sources of acidity, effervescing aids, or other like uses. Some examples of salts for use in such applications include sodium bisulfate, sodium acetate, sodium bicarbonate, citric acid salts, and the like and mixtures thereof. The composition can include in the range of 0.1 to 50% by weight such material. It should be understood that agents other than salts that act as pH modifiers, sources of acidity, effervescing aids, or like, can also be used in conjunction with the invention.

Alkalinity Sources

The cleaning composition of or employed in the present invention can include effective amounts of one or more inorganic detergents or alkaline sources to enhance cleaning of a substrate and improve soil removal performance of the composition. As discussed above, in embodiments including an alkali metal salt, such as alkali metal carbonate, the alkali metal salt can act as an alkalinity source. It should also be understood that in some embodiments, the active oxygen compound also can act as a source of alkalinity. The composition can include a secondary alkaline source separate from the active oxygen compound, and that secondary source can include about 0 to 75 wt-%, preferably about 0.1 to 70 wt-% of, in some embodiments, more preferably 1 to 25 wt-%, but in other embodiments, more preferably about 20 to 60 wt-% or 30 to 70 wt-% of the total composition.

Additional alkalinity sources can include, for example, inorganic alkalinity sources, such as an alkali metal hydroxide or silicate, or the like. Suitable alkali metal hydroxides include, for example, sodium or potassium hydroxide. An alkali metal hydroxide can be added to the composition in a variety of forms, including for example in the form of solid beads, powder, or other solid form, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50 wt-% and a 73 wt-% solution.

Examples of useful alkaline metal silicates include sodium or potassium silicate (with a M₂O:SiO₂ ratio of 1:2.4 to 5:1, M representing an alkali metal) or metasilicate.

Other sources of alkalinity include a metal borate such as sodium or potassium borate, and the like; ethanolamines and amines; and other like alkaline sources. Any of a variety of known sources of alkalinity can also be used in conjunction with the invention.

Antimicrobial Agent

The compositions of or employed in the invention can contain an added antimicrobial agent. This added antimicrobial agent can be dispersed or dissolved in the solid (e.g., powder) or agglomerate carpet or upholstery cleaning composition or in the diluting solvent. Suitable additional antimicrobial agents include sulfonic acids (e.g., dodecylbenzene sulfonic acid); iodo-compounds or active halogen compounds (e.g., iodine, interhalides, polyhalides, metal hypochlorites, hypochlorous acid and its alkali metal salts, hypobromous acid and its alkali metal salts, chloro- and bromo-hydantoins, sodium chlorite, sodium trichloroisocyanurate, sodium dichloro isocyanate (anhydrous or dihydrate), iodine-poly(vinylpyrolidinone) complexes, and 2-bromo-2-nitropropane-1,3-diol); additional active oxygen compounds (e.g., organic peroxides including benzoyl peroxide, alkyl benzoyl peroxides, ozone, singlet oxygen generators); phenolic derivatives (e.g., o-phenyl phenol, o-benzyl-p-chlorophenol, tert-amyl phenol, C₁-C₆ alkyl hydroxy benzoates, pentachlorophenol, orthophenylphenol, and p-chloro-m-xylenol); phenyl or benzyl benzoate; or other antimicrobial agents such as metal derivatives, amines, alkanol amines, nitro derivatives, analides, organosulfur and sulfur-nitrogen compounds (e.g, hexahydro-1,3,5-tris(2-hydroxyethyl)-s-triazine, dithiocarbamates such as sodium dimethyldithiocarbamate); or a mixture of such antimicrobial agents. Typically, an added antimicrobial agent is employed in an amount sufficient to provide the desired degree of antimicrobial activity.

Phenyl or benzyl benzoate can also be included in the compositions of or employed in the present invention as an agent against micro-insects that inhabit carpet or upholstery, such as dust mites.

Compositions of or employed in the invention containing such optional additional antimicrobial agents typically have substantially greater antimicrobial effectiveness than comparison aqueous solutions or dispersions containing the additional antimicrobial agent alone. If present in the solid (e.g., powder) or agglomerate compositions of or employed in the invention, the additional antimicrobial agent preferably is 0.01 to about 30 wt-% of the composition, preferably 0.05 to about 10 wt-% and most preferably about 0.1 to about 5 wt-%. In a use solution the additional antimicrobial agent preferably is 0.001 to about 5 wt-% of the composition, preferably 0.01 to about 2 wt-%, and preferably 0.05 to about 0.5 wt-%. In some embodiments, an antimicrobial component, such as TAED can be included in the range of 0.001 to 75 wt-% of the composition, preferably 0.01 to 20 wt-%, and more preferably 0.05 to 10 wt-% of the composition.

In use, the antimicrobial agents are typically formed into a solid (e.g., powder) or agglomerate functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Activators

In some embodiments, the antimicrobial activity or bleaching activity of the composition can be enhanced by the addition of a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent or can provide enhanced bleaching of stains. Other examples of active oxygen activators include transition metals and their compounds, compounds that contain a carboxylic, nitrile, or ester moiety, or other such compounds known in the art. Preferred activators include tetracetylethylenediamine, molybdenum-containing compound, polycarboxlic acid or its salts or esters (e.g. didecanoic acid), sulfonated or sulfated carboxylic acid or its salts or esters (e.g. the nonyl ester of the sulfonic acid of phenol), or mixtures thereof. In an embodiment, the activator includes tetraacetylethylene diamine; transition metal; compound that includes carboxylic, nitrile, amine, or ester moiety; or mixtures thereof.

In some embodiments, an activator component can include in the range of 0.001 to 75% by wt. of the composition, preferably 0.01 to 20, and more preferably 0.05 to 10% by wt of the composition.

In an embodiment, the activator for the active oxygen compound combines with the active oxygen to form an antimicrobial agent.

In an embodiment, the composition includes a solid block, and an activator material for the active oxygen is coupled to the solid block. The activator can be coupled to the solid block by any of a variety of methods for coupling one solid cleaning composition to another. For example, the activator can be in the form of a solid that is bound, affixed, glued or otherwise adhered to the solid block. Alternatively, the solid activator can be formed around and encasing the block. By way of further example, the solid activator can be coupled to the solid block by the container or package for the cleaning composition, such as by a plastic or shrink wrap or film.

Bleaching Agents

Bleaching agents for use in inventive formulations for lightening or whitening a substrate, include bleaching compounds capable of liberating an active halogen species, such as Cl₂, Br₂, I₂, ClO₂, BrO₂, IO₂, —OCl⁻, —OBr⁻ and/or, —OI⁻, under conditions typically encountered during the cleansing process. Suitable bleaching agents for use in the present cleaning compositions include, for example, chlorine-containing compounds such as a chlorite, a hypochlorite, chloramine. Preferred halogen-releasing compounds include the alkali metal dichloroisocyanurates, chlorinated trisodium phosphate, the alkali metal hypochlorites, alkali metal chlorites, monochloramine and dichloramine, and the like, and mixtures thereof. Encapsulated chlorine sources can also be used to enhance the stability of the chlorine source in the composition (see, for example, U.S. Pat. Nos. 4,618,914 and 4,830,773, the disclosure of which is incorporated by reference herein). A bleaching agent can also be an additional peroxygen or active oxygen source such as hydrogen peroxide, perborates, for example sodium perborate mono and tetrahydrate, sodium carbonate peroxyhydrate, phosphate peroxyhydrates, and potassium permonosulfate, with and without activators such as tetraacetylethylene diamine, and the like, as discussed above. A cleaning composition can include a minor but effective additional amount of a bleaching agent above that already available from the stabilized active oxygen compound, preferably about 0.1-10 wt-%, preferably about 1-6 wt-%.

Hardening Agents/Solubility Modifiers

The present compositions can include a minor but effective amount of a secondary hardening agent, as for example, an amide such stearic monoethanolamide or lauric diethanolamide, or an alkylamide, and the like; a polyvinylalcohol or polyvinylester and the like; a polyvinylacrylate and the like; microcrystalline cellulose and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds can also vary the solubility of the composition in an aqueous medium during use such that the cleaning agent and/or other active ingredients can be dispensed from the solid composition over an extended period of time. The composition can include a secondary hardening agent in an amount of about 5-20 wt-%, preferably about 10-15 wt-%.

Detergent Fillers

A cleaning composition can include an effective amount of one or more detergent fillers, which does not perform as a cleaning agent per se, but cooperates with the cleaning agent to enhance the overall processing of the composition. Examples of fillers suitable for use in the present cleaning compositions include sodium sulfate, sodium chloride, starch, sugars, C₁-C₁₀ alkylene glycols such as propylene glycol, and the like. Preferably, a detergent filler is included in an amount of about 1-20 wt-%, preferably about 3-15 wt-%.

Defoaming Agents

An effective amount of a defoaming agent for reducing the stability of foam can also be included in the present cleaning compositions. Preferably, the cleaning composition includes about 0.0001-5 wt-% of a defoaming agent, preferably about 0.01-3 wt-%.

Examples of defoaming agents suitable for use in the present compositions include silicone compounds such as silica dispersed in polydimethylsiloxane, EO/PO block copolymers, alcohol alkoxylates, fatty amides, hydrocarbon waxes, fatty acids, fatty esters, fatty alcohols, fatty acid soaps, ethoxylates, mineral oils, polyethylene glycol esters, alkyl phosphate esters such as monostearyl phosphate, and the like. A discussion of defoaming agents can be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated by reference herein. Preferred defoamers for carpet or upholstery cleaning include polysiloxanes.

Optical Brighteners

Optical brightener is also referred to as fluorescent whitening agents or fluorescent brightening agents provide optical compensation for the yellow cast in fabric substrates. With optical brighteners yellowing is replaced by light emitted from optical brighteners present in the area commensurate in scope with yellow color. The violet to blue light supplied by the optical brighteners combines with other light reflected from the location to provide a substantially complete or enhanced bright white appearance. This additional light is produced by the brightener through fluorescence. Optical brighteners absorb light in the ultraviolet range 275 through 400 nm. and emit light in the ultraviolet blue spectrum 400-500 nm.

Fluorescent compounds belonging to the optical brightener family are typically aromatic or aromatic heterocyclic materials often containing condensed ring system. An important feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.). The choice of optical brighteners for use in detergent compositions will depend upon a number of factors, such as the type of detergent, the nature of other components present in the detergent composition, the temperature of the wash water, the degree of agitation, and the ratio of the material washed to the tub size. The brightener selection is also dependent upon the type of material to be cleaned, e.g., cottons, synthetics, etc. Since most laundry detergent products are used to clean a variety of fabrics, the detergent compositions should contain a mixture of brighteners which are effective for a variety of fabrics. It is of course necessary that the individual components of such a brightener mixture be compatible.

Optical brighteners useful in the present invention are commercially available. Commercial optical brighteners which can be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents. Examples of these types of brighteners are disclosed in “The Production and Application of Fluorescent Brightening Agents”, M. Zahradnik, Published by John Wiley & Sons, New York (1982), the disclosure of which is incorporated herein by reference.

Stilbene derivatives which can be useful in the present invention include, but are not necessarily limited to, derivatives of bis(triazinyl)amino-stilbene; bisacylamino derivatives of stilbene; triazole derivatives of stilbene; oxadiazole derivatives of stilbene; oxazole derivatives of stilbene; and styryl derivatives of stilbene.

Dyes/Odorants

Various dyes, odorants including perfumes, and other aesthetic enhancing agents can also be included in the composition. Dyes can be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that can be included in the compositions include, for example, terpenoids such as citronellol, aldehydes such as amyl cinnamaldehyde, a jasmine such as C1S-jasmine or jasmal, vanillin, and the like.

Aqueous Medium

The ingredients can optionally be processed in a minor but effective amount of an aqueous medium such as water to achieve a mixture, to aid in the solidification, to provide an effective level of viscosity for processing the mixture, and to provide the processed composition with the desired amount of firmness and cohesion during discharge and upon hardening. In a preferred embodiment, the water serves as a processing medium and also forms part of the binding agent, as described hereinabove. The mixture during processing typically includes about 0.2-10 wt-% of an aqueous medium, preferably about 0.5-9 wt-%.

Processing, Packaging, and Dispensing of the Composition

The composition can be processed to a solid form by a variety of known methods. For example, solid blocks can be made by the process discussed in detail in the following U.S. Patents and patent applications: U.S. Pat. Nos. 6,177,392 B1; 6,150,324; and 6,156,715; and U.S. patent application Ser. No. 08/989,824; each of which is incorporated herein by reference. A powdered composition can be prepared by simple mixing of the composition's components. An agglomerate can also be prepared by a variety of well-known methods.

The composition can be packaged in a variety of type of packages or packaging materials, such as, for example, a simple bottle or jar, a unit dose tablet or block, a “tear and pour” pouch, or a water-soluble packet.

The composition can be dispensed by any of a variety of known methods, such as, for example, eroding a solid block into water or dissolving a powder or agglomerate into water.

Methods of Carpet or Upholstery Cleaning and Sanitizing

The present compositions can be employed for cleaning and/or sanitizing carpets, rugs, and other floor coverings and/or upholstery made from fiber, yarn, fabric, or other textiles. The compositions are suitable for cleaning or sanitizing any carpet, floor covering, or upholstery that can be cleaned by conventional methods or apparatus, provided those methods or apparatus can employ a solid (e.g., powder) or agglomerate cleaning composition or a liquid cleaning composition made from a solid (e.g., powder) or agglomerate cleaning composition. Applying the composition can be accomplished or followed by direction of a liquid stream or mist onto the carpet or upholstery, optionally rubbing and/or brushing the carpet or upholstery and, optionally, removing the composition from the carpet or upholstery, e.g., by blotting, rubbing, or vacuuming.

The compositions for the cleaning of carpet or upholstery according to the present invention can be used both for manual carpet or upholstery cleaning and carpet or upholstery cleaning machines. For carpet or upholstery cleaning machines the solid (e.g., powder) or agglomerate compositions can be mixed with liquid, typically water, to form a liquid use composition, typically an aqueous preparation. The liquid use composition or aqueous preparation can be formed by dissolving or mixing to achieve the desired concentration of product. Typically, compositions to be used in carpet or upholstery cleaning machines are formulated to be low foaming. The compositions of the present invention can be employed with any of a variety of carpet or upholstery cleaning machines. For example, the present use compositions can be applied by a carpet or upholstery cleaning machine that optionally heats the use composition, sprays it onto the carpet or upholstery, optionally brushes the carpet or upholstery, and vacuums up excess liquid. Alternatively, the present use compositions can be applied with a sprayer and rubbed or brushed into the carpet or upholstery with a rotating brush carpet or upholstery cleaning machine and the excess liquid removed by vacuum or blotting.

Liquid use compositions made from solid (e.g., powder) or agglomerate compositions according to the present invention can be applied directly onto the area to be treated or applied using a cloth, a sprayer, an aerosol can, a sponge, a brush, or another mechanical or electrical device (e.g. extractor, steam cleaner, etc.). In a preferred embodiment of the invention a liquid use composition is applied to the area to be treated by using a carpet extractor such as is available through a variety of commercial vendors. Such extractors spray a liquid use composition onto the area to be treated and optionally brush the surface and extract excess liquid from the surface via vacuum. In a preferred embodiment of the invention a liquid use composition is applied to the area to be treated and a rotary bonnet cleaning machine used to agitate the surface with excess liquid optionally vacuumed-up afterwards. In a preferred embodiment a liquid use composition is sprayed onto the surface which is then rubbed or brushed by hand and the excess liquid optionally removed by blotting or vacuum. A sprayer can be trigger operated, pump operated, electrically operated, or operated by any source of pressurized gas such as a can or a pressurizer. Typically, a sprayer uniformly covers the area to be treated.

Advantageously, cleaning action of the present compositions begins as soon as the compositions are applied onto the carpet or upholstery. Rubbing and/or brushing are not required for the cleaning process. However, mechanical action is useful to allow the liquid use composition to more quickly penetrate thick carpet or upholstery. Preferably, however, for highly soiled carpet or upholstery or in high traffic areas of carpet the present method for carpet or upholstery cleaning includes applying a the cleaning composition and then rubbing and/or brushing more or less intensively, for example with a sponge, brush, or other mechanical or electrical device, optionally with the aid of water. Typically the time spent rubbing or brushing is between 1 second to a few minutes per square meter. After applying the cleaning composition, and rubbing or brushing (if any), the composition is removed from the carpet or upholstery, preferably by mechanical means including brushing out and/or vacuuming up the excess liquid or dried composition.

The compositions for carpet or upholstery cleaning according to the present invention are preferably applied to the carpet or upholstery to be cleaned as a liquid use composition (e.g., an aqueous preparation). Typically, the user makes the liquid use composition by mixing the solid (e.g., powder) or agglomerate carpet or upholstery cleaning composition with water, or another carrier. Use compositions typically include about 0.1 to about 20 wt-%, about 0.1 to about 10 wt-%, about 0.1 to about 5 wt-%, or 0.5% to about 3 wt-% of the solid (e.g., powder) or agglomerate carpet or upholstery cleaning composition. The amount or concentration of the compositions employed for carpet or upholstery cleaning according to the present invention can depend on the severity of the stain or soil. In the case of stubborn stains, more than one application can be used to ensure complete removal of the stain.

However, the compositions herein are particularly useful in that for heavily soil areas it is often not necessary to pre-spot or pre-spray the area before cleaning, resulting in a significant reduction in labor over the present standard practice of pre-spotting stains followed by pre-spraying heavily soiled areas followed by extracting the entire surface. Indeed, the carpet or upholstery cleaning compositions herein are particularly suitable to remove dinginess from carpet or upholstery that results from a diffuse layer of soil and/or from general wear. In an embodiment of the present method, a liquid cleaning composition made from the present solid (e.g., powder) or agglomerate carpet or upholstery cleaning compositions can be left to dry on the carpet to dry residue which is less likely to attract dirt than a sticky residue. The powdery residue can then optionally be removed from the carpet or upholstery mechanically.

In another embodiment, the present compositions are applied as granular or powder compositions. Such compositions for carpet or upholstery cleaning of can be applied directly onto the area of the carpet or upholstery to be treated by, for example, sprinkling the composition over the area or using a sponge, a brush, or other mechanical or electrical device, preferably in presence of water.

The area to be treated employing compositions according to the present invention can be any size. For example, the present methods and compositions can be employed for cleaning all or part of a carpet or upholstery, even for removing individual spots.

According to the present invention the compositions herein can be used for the removal of stains and soils from carpets or upholstery as well as of odors. Removing stains from carpets or upholstery typically includes lightening the stain's color, preferably lightening the stain so that it is not or is only slightly visible to the human eye as well as mechanically removing the lightened soil from the surface. Stains can bleached by commercial available products called carpet brighteners which are typically just a bleaching agent such as sodium percarbonate. The sodium percarbonate alone is able to bleach the stain and reduce its intensity in color. However the soil that comprises the stain remains in place on the surface unless a bleaching and cleaning composition such as is described herein is used. Removing stains can be accomplished by applying a carpet or upholstery cleaning composition described herein to the stained area of the carpet or upholstery using the previously described methods. The amount of destaining is graded visually.

In addition the compositions according to the present invention can be used to sanitizer carpets and reduce the level of micro-insects such as dust mites in carpet or upholstery.

Liquid Use Compositions

As described herein above, liquid use compositions can be formed by mixing the solid (e.g. powder) or agglomerate cleaning composition with a liquid carrier. Preferably, the liquid is water and the liquid use composition is an aqueous preparation. Liquid use compositions can include about 0.1 to about 20 wt-% of the solid (e.g., powder) or agglomerate carpet or upholstery cleaning composition, preferably about 0.1 to about 10 wt-% of the solid (e.g., powder) or agglomerate carpet or upholstery cleaning composition, preferably about 0.1 to about 5 wt-% of the solid (e.g., powder) or agglomerate carpet or upholstery cleaning composition, most preferably about 0.5% to about 3 wt-% of the solid (e.g., powder) or agglomerate carpet or upholstery cleaning composition. Therefore, the liquid use compositions of or employed in the present invention can include the ranges or amounts of ingredients employed in the solid or agglomerate compositions multiplied, for example, by 0.1%, by 0.5%, by 3%, by 5%, by 10%, by 20%, or by any value within the ranges recited for liquid use compositions.

Preferred liquid use compositions (e.g., aqueous preparations) include about 0.1 to about 10 wt-% of the solid or agglomerate cleaning composition, and have a pH of about 7 to about 11. Preferably, the pH is about 9 to about 10, preferably, less than 10. Preferred liquid use compositions (e.g., aqueous preparations) include about 0.2 to about 9 wt-% active oxygen compound; about 0.005 to about 1.1 wt-% surfactant; and about 0.1 to about 6 wt-% builder; and have a pH of about 7 to about 11. Preferably, this pH is about 9 to about 10, preferably less than 10. Preferred liquid use compositions (e.g., aqueous preparations) include about 0.4 to about 0.9 wt-% active oxygen compound; about 0.01 to about 0.11 wt-% surfactant; and about 0.2 to about 0.6 wt-% builder. These preferred liquid use compositions can have a pH of about 9 to about 10, preferably less than 10.

The liquid use composition can include, for example, about 0.5 to about 0.8 wt-% sodium percarbonate; about 0.01 to about 0.2 wt-% alcohol ethoxylate, alkylbenzene sulfonate, or mixtures thereof; and about 0.2 to about 0.4 wt-% non-phosphate builder, preferably in an aqueous preparation. In certain embodiments, such an aqueous preparation has a pH of about 7 to about 11, of about 9 to about 10, or less than 10.

The present invention can be better understood with reference to the following examples. These examples are intended to be representative of specific embodiments of the invention, and are not intended as limiting the scope of the invention.

### EXAMPLES

### Example 1

### Carpet Cleaning and Sanitizing Employing the Methods and Compositions of the Present Invention

A solid (e.g., powder) or agglomerate carpet cleaning composition according to the present invention was formulated and tested for carpet sanitizing and stain removal.

Materials and Methods

A powdered test sanitizing composition was prepared by mixing ingredients together to achieve:

| Ingredient | Wt-% |
|---|---|
| Phosphonate, ATMP | 11 |
| Nonionic surfactant; C12, C15 | 9 |
| ethoxylate with 7EO | |
| Builder, Sodium Tripolyphosphate | 20 |
| Active Oxygen Compound, | 60 |
| Sodium Percarbonate | |

1.75 grams of this composition was diluted in 100 mL of water for use as in the following carpet sanitizer test method.

Carpet Sanitizer Test Method

A composition according to the present invention was tested for carpet sanitizing activity using a method provided by the Environmental Protection Agency (see, for example, DIS/TSS-8/Apr. 18, 1981, EFFICACY DATA REQUIREMENTS, Carpet Sanitizers, the disclosure of which is incorporated herein by reference).

For this method, samples of two types of carpets were used, one made of nylon and another made of olefin. Each type of carpet was cut into 8×12-in pieces and six 2×2 inch squares were cut from the backing side of the carpet, with the squares at least 4 in apart on center. Each carpet sample had its pile surface covered with aluminum foil, which was folded over edges to secure. The covered carpet was then steam sterilized and dried. Samples for further testing were determined to be free of residual bacteriostatic activity on the pile or backing. The carpet was mounted on a board.

Diluted standardized bacterial stock suspensions were applied to the 2×2 squares of carpet. The bacterial stock suspensions included Staphylococcus aureus ATCC 6538, Enterobacter aerogenes ATCC 13048, or Pseudomonas aeruginosa ATCC 15442. Each square was inoculated with 0.1 ml of the bacterial suspension having a concentration 10×10 bacteria per ml in phosphate buffer dilution water. The inoculated carpet was dried at 35-37° C. for 60 min with the foil wrap loosely in place.

Test sanitizer compositions and control compositions were uniformly applied to selected 2×2 carpet squares by spraying followed by brushing with a brush dipped in the appropriate composition. 20 mL of each composition was applied to each 2×2 sample of carpet. Portions of the carpet not having a composition applied were protected with the foil wrapping. The amount of sanitizing composition added was chosen for comparison to amounts that would be applied during actual in-place carpet sanitizing. The treated carpet remained at room temperature for 60 min for partial drying of the treated areas.

Following the 60-min drying, each 2×2-in square was cut free with flamed forceps and knife. Each square was transferred to a separate extraction bottle of neutralizer broth, which was then shaken vigorously for at least 1 min to free the bacteria from the carpet fibers. Reductions in bacteria due to sanitizing composition were determined by comparing the number of survivors from each treated test square against the average viable count from the scrubbed control squares. A reduction of at least 3-log was required for sanitizing activity.

Carpet Stain Removal Test

Carpet was stained with coffee or wine by pouring 20 mL of the material onto the carpet and allowing it to dry and cure for 2-3 days. The stained carpet was treated with a 0.5 wt % aqueous dilution of a composition according to the present invention, and also two commercial carpet spotters, one acidic and one basic. Treating included wetting the stained carpet with the composition or spotter, agitating the wetted area, and blotting away liquid with a paper towel. After the treated spots air dried overnight, they were compared for destaining and graded. Slight change in staining intensity that was mostly a color change was graded 1. A moderate reduction in intensity plus a color change was graded 2. Nearly complete reduction in staining with very little stain remaining was graded 3.

Results

The test composition caused a more than 3-log reduction in bacterial population against S. aureus, E. coli and Ps. aeruginosa in the carpet sanitizer test. The present compositions make effective carpet sanitizers.

The test composition was also effectively removed stains from carpet. These results are shown in Table 4 below.

TABLE 4
Carpet Stain Removal by a Composition According
to the Present Invention

| | Activity Against | Activity Against |
|---|---|---|
| Treatment | Coffee Stain | Wine Stain |
| Composition of the Present | 3 | 3 |
| Invention | | |
| Commercial Acidic Carpet | 2 | 2 |
| Spotter | | |
| Commercial Basic Carpet | 1 | 1 |
| Spotter | | |

Activity graded as: 1 = only a slight change in staining intensity that was mostly a color change; 2 = a moderate reduction in intensity plus a color change; and 3 = nearly a complete reduction in staining with very little stain remaining.

### Example 2

### Carpet Cleaning Field Test Employing the Methods and Compositions of the Present Invention

A solid (e.g., powder) or agglomerate carpet cleaning composition according to the present invention was used to clean a carpet in a conference room at a shopping mall in Bloomington, Minn.

Materials and Methods

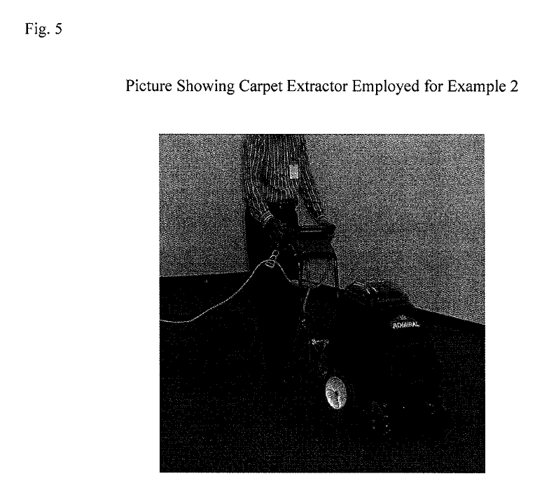

The composition of Example 1 was used dissolved in water at 1.0 wt-% and was applied with a commercial carpet extractor. FIG. 5 shows the extractor and operator.

For comparison purposes, a commercial liquid carpet cleaner was employed at the use concentration recommended on its label, a concentration of about 0.4 wt-% in water. The commercial liquid carpet cleaner included surfactant and builder, but not active oxygen compound.

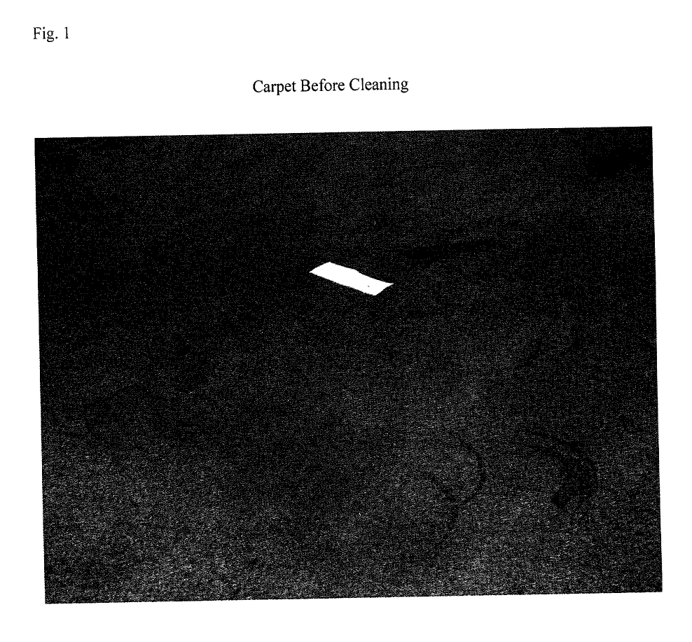

The carpet in the conference room was heavily stained and soiled, as shown in FIG. 1. The partial rings on the carpet in the foreground are about the size of the bottom of a 5 gallon pail and appear to have been made by the content of a such a pail containing some foodstuff (FIG. 1).

Results

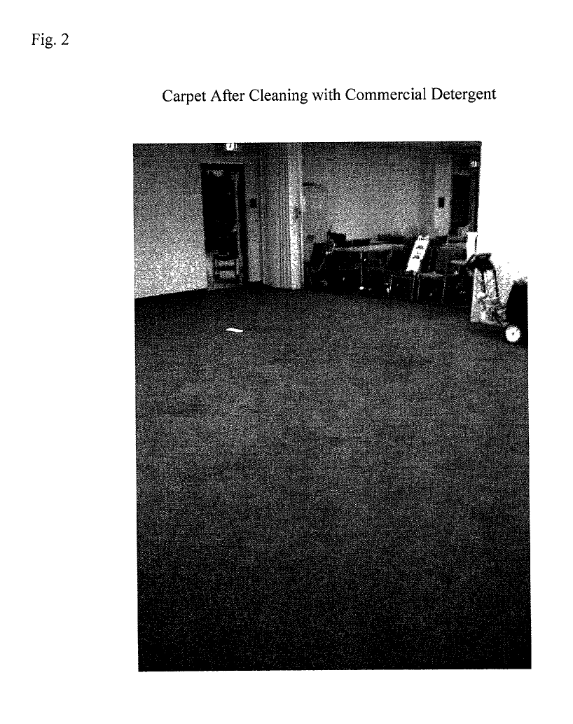

FIG. 1 shows the carpet before cleaning and is notable for the heavy degree of stain and soil. FIG. 2 shows the carpet after cleaning with the commercial detergent. The commercially cleaned carpet still shows numerous stains, for example several at the center of the photograph and one near the white paper towel near top center.

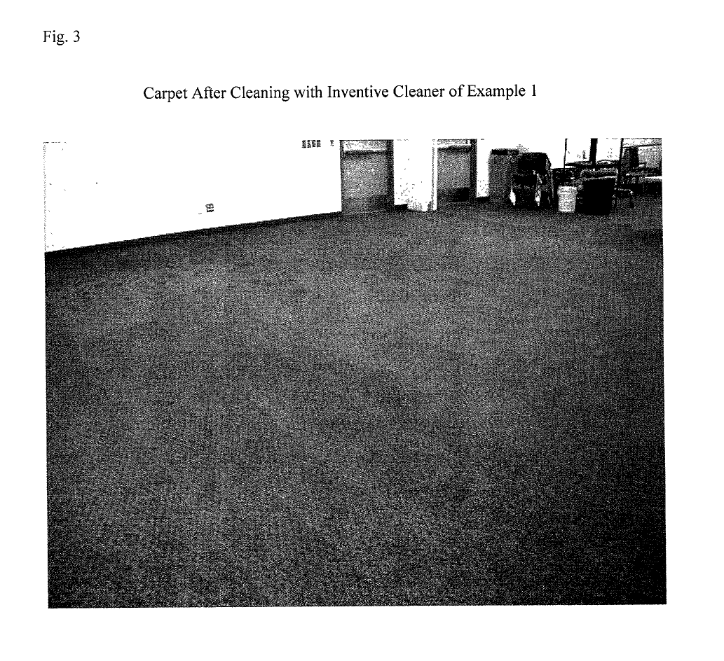

FIG. 3 shows the carpet after cleaning with the inventive composition and method. The carpet is sufficiently clean to show foot prints that have pressed the nap at the top of the photograph. The carpet cleaned by an inventive method and composition shows little or no staining.

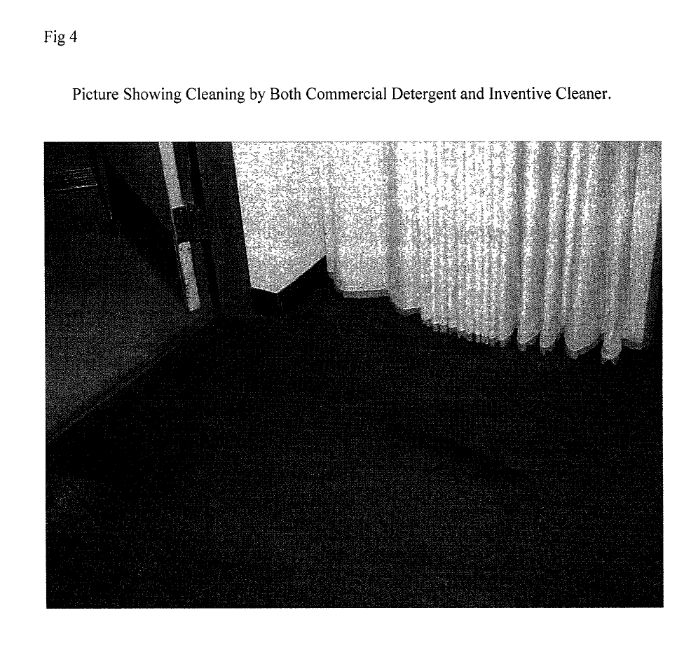

FIG. 4 illustrates the shortcomings of the commercial detergent compared to an inventive method and composition. The majority of the carpet shown in this Figure remains heavily soiled after cleaning with the commercial detergent. The small portion of carpet shown under the curtain was cleaned with an inventive method and composition. This small portion is much lighter due to substantial soil and stain removal.

### Example 3

### Carpet Sanitizing and Cleaning Employing Non-Phosphate Compositions of the Present Invention

A solid (e.g., powder) or agglomerate carpet cleaning composition according to the present invention was formulated and tested for carpet sanitizing and stain removal.

Materials and Methods

A powdered cleaning and sanitizing composition was prepared by blending together the components shown below.

| Ingredient | Wt-% |
|---|---|
| Sequestrant, Tetrasodium EDTA | 8.6 |
| Nonionic surfactant; C12, C15 | 8.1 |
| ethoxylate with 7EO | |
| Builder, Sodium Carbonate | 18.4 |
| pH modifier, citric acid | 12.3 |
| Active Oxygen Compound, | 52.6 |
| Sodium Percarbonate | |

Stain removal by this composition was tested by methods similar to those employed in Example 1 below, but employing motor oil as an additional staining soil. Briefly, a 1% solution of the non-phosphate cleaning composition was tested for the removal of coffee, wine, and dirty motor oil stains from white carpet using a small hand-held carpet extractor.

Results

Stain removal was found to be comparable to the phosphate formula described in Example 1. That is, for each stain, this non-phosphate composition caused nearly a complete reduction in staining with very little stain remaining.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. A method of cleaning carpet or upholstery, comprising:
applying to the carpet or upholstery an aqueous preparation of a solid or agglomerated cleaning composition, the solid or agglomerated cleaning composition comprising:
active oxygen compound comprising peroxygen moiety;
surfactant; and
builder.

2. The method of claim 1, wherein applying comprises extracting the carpet or upholstery.

3. The method of claim 1, wherein applying comprises brushing or rubbing the cleaning composition on the carpet.

4. The method of claim 1, wherein applying comprises pre-spotting, pre-spraying, or extracting the carpet or upholstery, or combinations thereof.

5. The method of claim 1, comprising applying the cleaning composition at a concentration and for a duration effective to achieve sanitizing the carpet or upholstery.

6. The method of claim 1, further comprising removing a portion of the composition from the carpet.

7. The method of claim 1, wherein the method omits pre-spotting the carpet or upholstery.

8. The method of claim 1, wherein the method omits pre-spraying the carpet or upholstery.

9. The method of claim 1, wherein the aqueous preparation comprises about 0.1 to about 10 wt-% of the solid or agglomerated cleaning composition, and a pH of about 7 to about 11.

10. The method of claim 9, wherein the aqueous preparation comprises a pH of about 9 to about 10.

11. The method of claim 10, wherein the aqueous preparation comprises a pH less than 10.

12. The method of claim 1, wherein the cleaning composition comprises:
about 1 to about 99 wt-% active oxygen compound;
about 0.1 to about 50 wt-% surfactant; and
about 1 to about 99 wt-% builder.

13. The method of claim 12, wherein the cleaning composition comprises:
about 15 to about 65 wt-% active oxygen compound;
about 2 to about 20 wt-% surfactant; and
about 15 to about 65 wt-% builder.

14. The method of claim 13, wherein the cleaning composition comprises:
about 40 to about 80 wt-% active oxygen compound;
about 4 to about 15 wt-% surfactant; and
about 15 to about 45 wt-% builder.

15. The method of claim 14, wherein the cleaning composition comprises:
about 50 to about 60 wt-% active oxygen compound;
about 8 to about 10 wt-% surfactant; and
about 25 to about 30 wt-% builder.

16. The method of claim 1, wherein the cleaning composition comprises:
about 70 to about 95 wt-% active oxygen compound;
about 1 to about 15 wt-% surfactant; and
about 5 to about 30 wt-% builder.

17. The method of claim 1, wherein the cleaning composition comprises:
about 5 to about 30 wt-% active oxygen compound;
about 1 to about 15 wt-% surfactant; and
about 55 to about 95 wt-% builder.

18. The method of claim 1, wherein the cleaning composition comprises:
about 50 to about 80 wt-% active oxygen compound;
about 1 to about 15 wt-% surfactant; and
about 15 to about 55 wt-% builder.

19. The method of claim 18, wherein the cleaning composition comprises:
about 50 to about 60 wt-% active oxygen compound;
about 6 to about 10 wt-% surfactant; and
about 15 to about 25 wt-% builder.

20. The method of claim 1, wherein the cleaning composition comprises:
about 60 to about 80 wt-% active oxygen compound;
about 6 to about 10 wt-% surfactant; and
about 20 to about 30 wt-% builder.

21. The method of claim 1, wherein the cleaning composition comprises:
about 60 to about 80 wt-% active oxygen compound;
about 1 to about 3 wt-% surfactant; and
about 15 to about 25 wt-% builder.

22. The method of claim 1, wherein the cleaning composition comprises:
about 50 to about 60 wt-% active oxygen compound;
about 1 to about 3 wt-% surfactant; and
about 30 to about 40 wt-% builder.

23. The method of claim 1, wherein the cleaning composition comprises:
about 5-15% phosphonate;
about 15-25% condensed phosphate;
about 5-10% nonionic surfactant;
about 55-65% hydrogen peroxide adduct.

24. The method of claim 1, wherein the cleaning composition comprises:
about 5-10% aminocarboxylate;
about 5-10% nonionic surfactant;
about 15-25% alkali metal carbonate;
about 10-15% carboxylic acid;
about 50-60% hydrogen peroxide adduct.

25. The method of claim 1, wherein the cleaning composition comprises:
about 5-15% aminocarboxylate;
about 1-5% nonionic surfactant;
about 10-30% alkali metal carbonate, alkali metal bicarbonate, or mixtures thereof
about 50-90% hydrogen peroxide adduct.

26. The method of claim 1, wherein the cleaning composition comprises as active oxygen compound inorganic active oxygen compound, organic active oxygen compound, or mixtures thereof.

27. The method of claim 26, wherein the inorganic active oxygen compound comprises hydrogen peroxide adduct.

28. The method of claim 26, wherein the inorganic active oxygen compound comprises percarbonate, perborate, persulfate, perphosphate, persilicate, or mixtures thereof.

29. The method of claim 1, wherein the cleaning composition comprises as surfactant nonionic surfactant, amphoteric surfactant, anionic surfactant, or mixtures thereof.

30. The method of claim 29, wherein the nonionic surfactant comprises alcohol ethoxylate, alcohol propoxylate, alcohol ethoxylate-propoxylate, or mixtures thereof.

31. The method of claim 30, wherein the nonionic surfactant comprises a solid, powder, or paste at 20° C.

32. The method of claim 1, wherein the cleaning composition comprises as builder zeolite, citric or citrate-type chelating agent, alkyl diamine polyacetic acid-type chelating agent, acrylic or polyacrylic acid-type stabilizing agent, phosphonic acid or phosphonate-type chelating agent, aminocarboxylic acid, condensed phosphate, polymeric polycarboxylate, or a mixture thereof.

33. The method of claim 32, wherein the builder comprises phosphonate and the phosphonate comprises amino tri(methylene phosphonic) acid; 1-hydroxyethylidene-1,1-diphosphonic acid; diethylenetriaminopenta(methylene phosphonic) acid; alanine-N,N-diacetic acid; diethylenetriaminepentaacetic acid; salts thereof; or mixtures thereof.

34. The method of claim 32, wherein the builder comprises condensed phosphate and the condensed phosphate comprises sodium tripolyphosphate, potassium tripolyphosphate, magnesium tripolyphosphate, sodium pyrophosphate, potassium pyrophosphate, sodium hexametaphosphate, potassium hexametaphosphate, or a mixture thereof.

35. The method of claim 32, wherein the builder comprises nitrilotriacetate, citric acid, ethylene diamine tetraacetate, salt thereof, or mixture thereof.

36. The method of claim 1, wherein the cleaning composition further comprises alkalinity source, acidity source, cleaning enzyme, hardening agent, solubility modifier, detergent filler, defoamer, antimicrobial agent, a precipitation threshold agent or system, aesthetic enhancing agent, effervescent agent, activator for the active oxygen compound, or combinations thereof.

37. The method of claim 36, wherein the cleaning composition comprises nonionic surfactant, phosphonate, condensed phosphate, hydrogen peroxide adduct, C1-C6 carboxylic acid, alkali metal hydrogen carbonate, alkali metal hydrogen phosphate, alkali metal hydrogen sulfate, or combinations thereof.

38. The method of claim 36, wherein the cleaning composition comprises nonionic surfactant, aminocarboxylate, hydrogen peroxide adduct, C1-C6 carboxylic acid, alkali metal hydrogen carbonate, alkali metal hydrogen phosphate, alkali metal hydrogen sulfate, or combinations thereof

39. A method of sanitizing carpet or upholstery, comprising:
applying to the carpet or upholstery an aqueous preparation of a solid or agglomerated cleaning composition, the solid or agglomerated cleaning composition comprising:
active oxygen compound comprising peroxygen moiety;
surfactant; and
builder.

40. A method of cleaning carpet or upholstery, comprising:
applying to the carpet or upholstery a powdered or agglomerated cleaning composition comprising:
active oxygen compound comprising peroxygen moiety;
surfactant; and
builder.

41. A method of sanitizing carpet or upholstery, comprising:
applying to the carpet or upholstery a powdered or agglomerated cleaning composition comprising:
active oxygen compound comprising peroxygen moiety;
surfactant; and
builder.

42. A method for removing a stain from carpet or upholstery, comprising:
applying to the carpet or upholstery an aqueous preparation of a solid or agglomerated cleaning composition, the solid or agglomerated cleaning composition comprising:
active oxygen compound comprising peroxygen moiety;
surfactant; and
builder or sequestrant.

43. A method for removing a stain from carpet or upholstery, comprising:
applying to the carpet or upholstery a solid or agglomerated cleaning composition, the solid or agglomerated cleaning composition comprising:
active oxygen compound comprising peroxygen moiety;
surfactant; and
builder or sequestrant.

44. A solid or agglomerated carpet or upholstery cleaning composition comprising:
about 40 to about 90 wt-% active oxygen compound;
about 1 to about 11 wt-% surfactant; and
about 20 to about 60 wt-% builder.

45. The composition of claim 44, comprising:
about 50 to about 80 wt-% active oxygen compound;
about 5 to about 11 wt-% surfactant; and
about 20 to about 35 wt-% builder.

46. The composition of claim 45, comprising:
about 80 wt-% active oxygen compound;
about 2 wt-% surfactant; and
about 18 wt-% builder.

47. The composition of claim 44, comprising:
about 50 to about 70 wt-% active oxygen compound;
about 1 to about 5 wt-% surfactant; and
about 20 to about 40 wt-% builder.

48. The composition of claim 44, comprising:
about 55 wt-% active oxygen compound;
about 8 wt-% surfactant; and
about 20 wt-% builder.

49. The composition of claim 44, comprising:
about 50 to about 60 wt-% active oxygen compound;
about 8 to about 10 wt-% surfactant; and
about 25 to about 30 wt-% builder.

50. The composition of claim 44, comprising:
about 60 to about 80 wt-% active oxygen compound;
about 6 to about 10 wt-% surfactant; and
about 20 to about 30 wt-% builder.

51. The composition of claim 44, comprising:
about 50 to about 60 wt-% active oxygen compound;
about 1 to about 3 wt-% surfactant; and
about 30 to about 40 wt-% builder.

52. The composition of claim 44, comprising:
about 5-10% aminocarboxylate;
about 5-10% nonionic surfactant;
about 15-25% alkali metal carbonate;
about 10-15% carboxylic acid;
about 50-60% hydrogen peroxide adduct.

53. The composition of claim 44, comprising:
about 50 to about 70 wt-% active oxygen compound;
about 7 to about 11 wt-% surfactant; and
about 25 to about 35 wt-% builder.

54. The composition of claim 44, comprising as active oxygen compound inorganic active oxygen compound, organic active oxygen compound, or mixtures thereof.

55. The composition of claim 54, wherein the active oxygen compound comprises inorganic active oxygen compound.

56. The composition of claim 55, wherein the inorganic active oxygen compound comprises hydrogen peroxide adduct.

57. The composition of claim 55, wherein the inorganic active oxygen compound comprises percarbonate, perborate, persulfate, perphosphate, persilicate, or mixtures thereof.

58. The composition of claim 54, wherein the active oxygen compound comprises organic active oxygen compound.

59. The composition of claim 44, comprising as surfactant nonionic surfactant, amphoteric surfactant, anionic surfactant, or mixtures thereof.

60. The composition of claim 59, wherein the nonionic surfactant comprises alcohol ethoxylate, alcohol propoxylate, alcohol ethoxylate-propoxylate, or mixtures thereof.

61. The composition of claim 60, wherein the nonionic surfactant comprises a solid, powder, or paste at 20° C.

62. The composition of claim 44, comprising as builder zeolite, citric or citrate-type chelating agent, alkyl diamine polyacetic acid-type chelating agent, acrylic or polyacrylic acid-type stabilizing agent, phosphonic acid or phosphonate-type chelating agent, aminocarboxylic acid, condensed phosphate, polymeric polycarboxylate, or a mixture thereof.

63. The composition of claim 62, wherein the builder comprises phosphonate and the phosphonate comprises amino tri(methylene phosphonic) acid; 1-hydroxyethylidene-1,1-diphosphonic acid; diethylenetriaminopenta(methylene phosphonic) acid; alanine-N,N-diacetic acid; diethylenetriaminepentaacetic acid; salts thereof; or mixtures thereof.

64. The composition of claim 62, wherein the builder comprises condensed phosphate and the condensed phosphate comprises sodium tripolyphosphate, potassium tripolyphosphate, magnesium tripolyphosphate, sodium pyrophosphate, potassium pyrophosphate, sodium hexametaphosphate, potassium hexametaphosphate, or a mixture thereof.

65. The composition of claim 62, wherein the builder comprises nitrilotriacetate, citric acid, ethylene diamine tetraacetate, salt thereof, or mixture thereof.

66. The composition of claim 44, further comprising alkalinity source, acidity source, cleaning enzyme, hardening agent, solubility modifier, detergent filler, defoamer, antimicrobial agent, a precipitation threshold agent or system, aesthetic enhancing agent, effervescent agent, activator for the active oxygen compound, or combinations thereof.

67. The composition of claim 66, comprising nonionic surfactant, phosphonate, condensed phosphate, hydrogen peroxide adduct, C1-C6 carboxylic acid, alkali metal hydrogen carbonate, alkali metal hydrogen phosphate, alkali metal hydrogen sulfate, or combinations thereof.

68. The composition of claim 66, comprising nonionic surfactant, aminocarboxylate, hydrogen peroxide adduct, C 1-C6 carboxylic acid, alkali metal hydrogen carbonate, alkali metal hydrogen phosphate, alkali metal hydrogen sulfate, or combinations thereof.

69. A solid or agglomerated carpet or upholstery cleaning composition comprising:
about 50 to about 70 wt-% active oxygen compound;
about 1 to about 5 wt-% surfactant; and
about 20 to about 40 wt-% builder.

70. A solid or agglomerated carpet or upholstery cleaning composition comprising:
about 50 to about 60 wt-% active oxygen compound;
about 8 to about 10 wt-% surfactant; and
about 25 to about 30 wt-% builder.

71. A solid or agglomerated carpet or upholstery cleaning composition comprising:
about 60 to about 80 wt-% active oxygen compound;
about 6 to about 10 wt-% surfactant; and
about 20 to about 30 wt-% builder.

72. A solid or agglomerated carpet or upholstery cleaning composition comprising:
about 50 to about 60 wt-% active oxygen compound;
about 1 to about 3 wt-% surfactant; and
about 30 to about 40 wt-% builder.

73. A solid or agglomerated carpet or upholstery cleaning composition comprising:
about 50 to about 70 wt-% active oxygen compound;
about 7 to about 11 wt-% surfactant; and
about 25 to about 35 wt-% builder.

74. A solid or agglomerated carpet or upholstery cleaning composition, comprising:
about 50 to about 80 wt-% sodium percarbonate;
about 1 to about 11 wt-% alcohol ethoxylate, alkylbenzene sulfonate, or mixtures thereof; and
about 20 to about 40 wt-% non-phosphate builder.

75. A method of cleaning carpet or upholstery, comprising:
applying to the carpet or upholstery an aqueous preparation of a solid or agglomerated cleaning composition, the aqueous preparation comprising:
about 0.5 to about 0.8 wt-% sodium percarbonate;
about 0.01 to about 0.2 wt-% alcohol ethoxylate, alkylbenzene sulfonate, or mixtures thereof; and
about 0.2 to about 0.4 wt-% non-phosphate builder.

76. The method of claim 75, wherein the aqueous preparation has a pH of about 7 to about 11.

77. The method of claim 76, wherein the aqueous preparation has a pH of about 9 to about 10.

78. The method of claim 77, wherein the aqueous preparation has a pH less than 10.

79. An aqueous preparation for cleaning carpet or upholstery comprising:
about 0.2 to about 9 wt-% active oxygen compound;
about 0.005 to about 1.1 wt-% surfactant; and
about 0.1 to about 6 wt-% builder;
wherein the aqueous preparation has a pH of about 7 to about 11.

80. The aqueous preparation of claim 79, having a pH of about 9 to about 10.

81. The aqueous preparation of claim 80, having a pH less than 10.

82. The aqueous preparation of claim 79, comprising
about 0.4 to about 0.9 wt-% active oxygen compound;
about 0.01 to about 0.11 wt-% surfactant; and
about 0.2 to about 0.6 wt-% builder.

83. The aqueous preparation of claim 82, having a pH less than 10.

84. An aqueous preparation for cleaning carpet or upholstery comprising:
about 0.5 to about 0.8 wt-% sodium percarbonate;
about 0.01 to about 0.2 wt-% alcohol ethoxylate, alkylbenzene sulfonate, or mixtures thereof; and
about 0.2 to about 0.4 wt-% non-phosphate builder.
